(19) United States
(12) Patent Application Publication
(10) Pub. No.: US 2025/0284452 A1
(43) Pub. Date: Sep. 11, 2025

(54) SYNCHRONIZED MUSIC ON TWO-WAY SMART RADIO DEVICES FOR FRONTLINE WORKERS

(71) Applicant: Weavix, Inc., Wichita, KS (US)

(72) Inventors: Kevin TURPIN, Wichita, KS (US); Benjamin BURRUS, Wichita, KS (US)

(21) Appl. No.: 18/915,309

(22) Filed: Oct. 14, 2024

Related U.S. Application Data
(60) Provisional application No. 63/562,871, filed on Mar. 8, 2024.

(51) Int. Cl. G06F 3/16; H04W 4/021

(52) U.S. Cl. CPC G06F 3/165; H04W 4/022

(57) ABSTRACT

A platform enables a user of a smart radio device to select a music channel for playback through a loudspeaker coupled to the smart radio device. The smart radio is configured for two-way communication and belongs to a group of smart radio devices associated with a facility. The platform sets parameter(s) for playback of music at the smart radio device in accordance with rule(s) that are implemented for the facility and cause the smart radio device to respond to an event detected at the smart radio device by performing an action. The event is based on a location of the smart radio device relative to a geofenced area of the facility or presence of a device, equipment, or machine in a threshold vicinity of the smart radio device. The action can include modifying value(s) of the parameter(s) of playback of music.

### CROSS-REFERENCE TO RELATED APPLICATION

This application claims the benefit of priority to U.S. Provisional Pat. App. No. 63/562,871 filed on Mar. 8, 2024 and is hereby incorporated by reference in its entirety.

### TECHNICAL FIELD

The present disclosure is generally related to wireless communication handsets and systems that playback audio such as music.

### BACKGROUND

Frontline workers often rely on radios to enable them to communicate with their team members. Traditional radios may fail to provide some communication services, requiring workers to carry additional devices to stay adequately connected to their team. Often, these devices are unfit for in-field use due to their fragile design or their lack of usability during frontline work. For example, smartphones, laptops, or tablets with additional communication capabilities may be easily damaged in the field, difficult to use in a dirty environment or when wearing protective equipment, or overly bulky for daily transportation on site. Accordingly, workers may be less accessible to their teams, which can lead to safety concerns and a decrease in productivity.

### BRIEF DESCRIPTION OF THE DRAWINGS

FIG. 1 is a block diagram illustrating an example architecture for an apparatus for device communication and tracking, in accordance with one or more embodiments.

FIG. 2 is a drawing illustrating an example apparatus for device communication and tracking, in accordance with one or more embodiments.

FIG. 3 is a drawing illustrating an example charging station for apparatuses implementing device communication and tracking, in accordance with one or more embodiments.

FIG. 4A is a drawing illustrating an example environment for apparatuses and communication networks for device communication and tracking, in accordance with one or more embodiments.

FIG. 4B is a flow diagram illustrating an example process for generating a work experience profile, in accordance with one or more embodiments.

FIG. 5 is a drawing illustrating an example facility using apparatuses and communication networks for device communication and tracking, in accordance with one or more embodiments.

FIG. 6 illustrates an example of a worksite that includes a plurality of geofenced areas, in accordance with one or more embodiments.

FIG. 7 is a block diagram illustrating an example machine learning (ML) system, in accordance with one or more embodiments.

FIG. 8 is a diagram that illustrates a process for controlling playback of music at smart radio devices, in accordance with one or more embodiments.

FIG. 9 includes various views of the interface on the smart radio device used to access the music service, in accordance with one or more embodiments associated with distinct features that are displayed as the user navigates the music service.

FIG. 10 is a block diagram of a transformer neural network, which may be used in examples of the present disclosure.

FIG. 11 is a block diagram illustrating an example computer system, in accordance with one or more embodiments.

FIG. 12 is a flowchart that illustrates a method for orchestrating music on smart radio devices to improve engagement of frontline workers.

FIG. 13 is a flowchart that illustrates a method for enhancing worker management and safety using smart radio devices via an audio notification.

FIG. 14 is a flowchart that illustrates a method to control playback parameters via an operating system, mobile device management app, or mobile application management app hosted on the smart radio device to enhance worker management and safety through dynamic control and event-triggered actions.

FIG. 15 is a flowchart that illustrates a method for modifying music playback via an application programming interface (API).

### DETAILED DESCRIPTION

The technology relates to controlling music that is played on a two-way smart radio device to promote engagement among frontline workers (“workers”) who are users of the smart radio devices and provide safety mechanisms to ensure that the works maintain situational awareness so that they can perform their jobs safely. Moreover, the technology enables using the engagement of workers with a music service to deliver safety and training information, or other information that improves the situational awareness of the workers.

In one implementation, an audio service can act as a source of music (e.g., radio, playlist) to playback devices that are hosted by a platform that manages workers. AN example of the playback devices includes fungible smart radio devices, smartphones, and tablets. The platform controls playback of the music on the playback devices based on, for example, whether the smart radio devices are associated with workers of a particular facility, the locations of the smart radio devices in the particular facility, and information about the particular worker using the smart radio device. In one example, the platform implements different rulesets for different facilities, different zones, and/or different users. As such, the platform can synchronize music and supplemental audio to one or more groups of smart radio devices.

In one example, different groups of workers in a common facility can experience different synchronized music experiences. For example, one group of users may select to listen to one type of music (e.g., country, rock, pop, hip hop), while another group of users may select to listen to another type of music. The platform can coordinate the playback experience for the different groups while simultaneously providing supplemental audio information across all groups of workers. In one example, the smart radios include light emitters that are used to signal that certain smart radio devices belong to certain groups (e.g., green light indicates that the group of smart radio devices are all playing the same country song). As such, individual workers can identify with others who are listening to the same

The platform can control safety features such as threshold volume limits or automatic attenuation or muting of the music depending on the location of the smart radio or whether an emergency event occurred near a location. The platform can control an electronic DJ that integrates Artificial Intelligence (AI) generated messages that are rendered as audio that plays over or instead of the music being rendered by selected smart radio devices or across groups of devices. For example, an AI system can monitor the state, behavior, or location of users to trigger generation of different messages that are played to warn the users of risks or harms. In one example, the smart radio devices are assigned for a location such that a geofences are used to control audio based on a zone, a role of the worker, and/or a type of task being performed by the worker using the smart radio device. The messages that are rendered on particular smart radio devices can be played in native languages of their users. That is, the same message can be converted into different languages and routed to different smart radio devices for different users.

The smart radio devices can be used to communicate between various workers. As the responsibilities of these workers adapt with technology, however, the functionality of mobile radio devices must evolve to provide additional functionality. For example, mobile radio devices have been improved to increase connectivity in previously disconnected locations. Moreover, improvements in mobile radio devices enable workers to communicate through additional forms of communication, often without user intervention. Mobile radio devices also provide a mechanism for tracking workers and equipment on a worksite to improve safety and efficiency. Mobile radio devices can further track details about employees during their work shift, and that information can be used to analyze the employees' strengths and weaknesses. For example, the mobile radio devices can track an employee's movements within the facility during their work shift via integrated sensors. The data tracked from the employees can then be used to infer insights on productivity, experience, and accident or hazards. Accordingly, the present disclosure relates to improvements in mobile radio devices. In general, improvements are directed to one of four technical aspects (“pillars”): network connectivity, collaboration, location services, and data, which are explained below.

Network connectivity: Smart radios operate using multiple onboard radios and connect to a set of known networks. This pillar refers to radio selection (e.g., use of multiple onboard radios in various contexts) and network selection (e.g., selecting which network to connect to from available networks in various contexts). These decisions may depend on data obtained from other pillars; however, inventions directed to the connectivity pillar have outputs that relate to improvements to network or radio communications/selections.

Collaboration: This pillar relates to communication between users. A collaboration platform includes chat channel selection, audio transcription and interpretation, sentiment analysis, and workflow improvements. The associated smart radio devices further include interface features that improve ease of communication through reduction in button presses and hands-free information delivery. Inventions in this pillar relate to improvements or gained efficiencies in communicating between users and/or the platform itself.

Location services: This pillar refers to various means of identifying the location of devices and people. There are straightforward or primary means, such as the Global Positioning System (GPS), accelerometer, or cellular triangulation. However, there are also secondary means by which known locations (via primary means) are used to derive the location of other unknown devices. For example, a set of smart radio devices with known locations are used to triangulate other devices or equipment. Further location services inventions relate to identification of the behavior of human users of the devices, e.g., micromotions of the device indicate that it is being worn, whereas lack of motion indicates that the device has been placed on a surface. Inventions in this pillar relate to the identification of the physical location of objects or workers.

Data: This pillar relates to the “Internet of Workers” platform. Each of the other pillars leads to the collection of data. Implementation of that data into models provides valuable insights that illustrate a given worksite to users who are not physically present at that worksite. Such insights include productivity of workers, experience of workers, and accident or hazard mapping. For example, the workers can have the smart radio device within a specified work zone in a facility, where the worker is moving around the work zone. As the worker is actively moving within the specified work zone of the facility, data is being collected by the smart radio device. The data collected by the smart radio device moving around the specified work zone can be used to infer that worker is being productive. Inventions in the data pillar relate to deriving insight or conclusions from one or more sources of data collected from any available sensor in the worksite.

Embodiments of the present disclosure will now be described with reference to the following figures. Although illustrated and described with respect to specific examples, embodiments of the present disclosure can be embodied in many different forms and should not be construed as limited to the embodiments set forth herein. Accordingly, the examples set forth herein are non-limiting examples referenced to improve the description of the present technology.

### Portable Wireless Apparatus

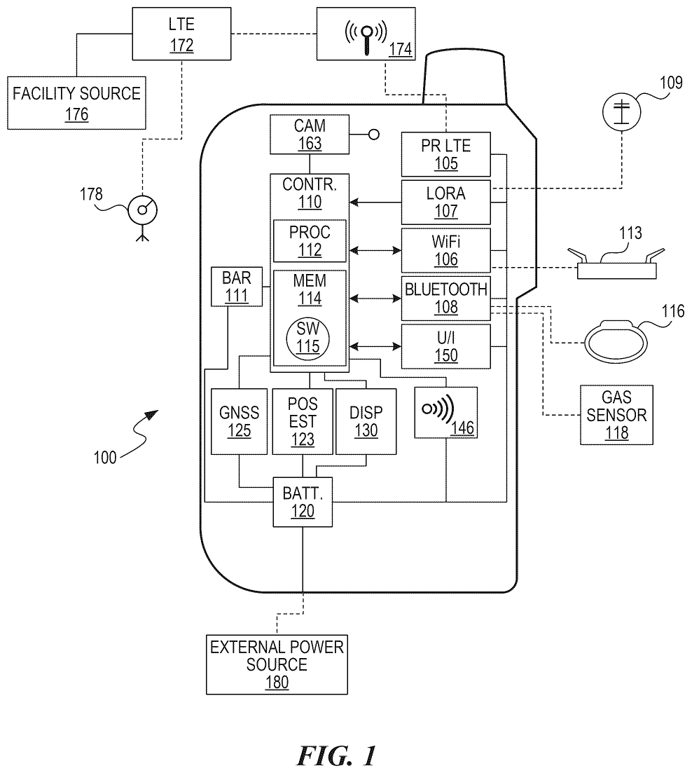

FIG. 1 is a block diagram illustrating an example architecture for an apparatus 100 for device communication and tracking, in accordance with one or more embodiments. The wireless apparatus 100 is implemented using components of the example computer system illustrated and described in more detail with reference to subsequent figures. In embodiments, the apparatus 100 is used to execute the ML system illustrated and described in more detail with reference to subsequent figures. The architecture shown by FIG. 1 is incorporated into a portable wireless apparatus 100, such as a smart radio, a smart camera, a smart watch, a smart headset, or a smart sensor. Although illustrated in a particular configuration, different embodiments of the apparatus 100 include different and/or additional components connected in different ways.

The apparatus 100 includes a controller 110 communicatively coupled either directly or indirectly to a variety of wireless communication arrangements. The apparatus 100 includes a position estimating component 123 (e.g., a dead-reckoning system), which estimates current position using inertia, speed, and intermittent known positions received from a position tracking component 125, which, in embodiments, is a Global Navigation Satellite System (GNSS) component. A battery 120 is electrically coupled with a cellular subsystem 105 (e.g., a private Long-Term Evolution (LTE) wireless communication subsystem), a Wi-Fi subsystem 106, a low-power wide area network (LPWAN) (e.g., LPWAN/long-range (LoRa) network subsystem 107), a Bluetooth subsystem 108, a barometer 111, an audio device 146, a user interface 150, and a built-in camera 163 for providing electrical power.

The battery 120 can be electrically and communicatively coupled with the controller 110 for providing electrical power to the controller 110 and to enable the controller 110 to determine a status of the battery 120 (e.g., a state of charge). In embodiments, the battery 120 is a non-removable rechargeable battery (e.g., using external power source 180). In this way, the battery 120 cannot be removed by a worker to power down the apparatus 100, or subsystems of the apparatus 100 (e.g., the position tracking component 125), thereby ensuring connectivity to the workforce throughout their shift. Moreover, the apparatus 100 cannot be disconnected from the network by removing the battery 120, thereby reducing the likelihood of device theft. In some cases, the apparatus 100 can include an additional, removable battery to enable the apparatus 100 to be used for prolonged periods without requiring additional charging time.

The controller 110 is, for example, a computer having a memory 114, including a non-transitory storage medium for storing software 115, and a processor 112 for executing instructions of the software 115. In some embodiments, the controller 110 is a microcontroller, a microprocessor, an integrated circuit (IC), or a system-on-a-chip (SoC). The controller 110 can include at least one clock capable of providing time stamps or displaying time via display 130. The at least one clock can be updatable (e.g., via the user interface 150, the position tracking component 125, the Wi-Fi subsystem 106, the private cellular network 107 subsystem, a server, or a combination thereof).

The wireless communications arrangement can include a cellular subsystem 105, a Wi-Fi subsystem 106, a LPWAN/LoRa network subsystem 107 wirelessly connected to a LPWAN network 109, or a Bluetooth subsystem 108 enabling sending and receiving. Cellular subsystem 105, in embodiments, enables the apparatus 100 to communicate with at least one wireless antenna 174 located at a facility (e.g., a manufacturing facility, a refinery, or a construction site), examples of which may be illustrated in and described with respect to the subsequent figures.

In embodiments, a cellular edge router arrangement 172 is provided for implementing a common wireless source. The cellular edge router arrangement 172 (sometimes referred to as an “edge kit”) can provide a wireless connection to the Internet. In embodiments, the LPWAN network 109, the wireless cellular network, or a local radio network is implemented as a local network for the facility usable by instances of the apparatus 100. For example, the cellular type can be 2G, 3G, 4G, LTE, 5G, etc. The edge kit 172 is typically located near a facility's primary Internet source 176 (e.g., a fiber backhaul or other similar device). Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle, or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHZ). For example, the apparatus 100 can operate using a duplex mode implemented using time division duplexing (TDD) or frequency division duplexing (FDD).

The Wi-Fi subsystem 106 enables the apparatus 100 to communicate with an access point 113 capable of transmitting and receiving data wirelessly in a relatively high-frequency band. In embodiments, the Wi-Fi subsystem 106 is also used in testing the apparatus 100 prior to deployment. The Bluetooth subsystem 108 enables the apparatus 100 to communicate with a variety of peripheral devices, including a biometric interface device 116 and a gas/chemical detection sensor 118 used to detect noxious gases. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the Internet (“the cloud”) for accessing websites, databases, etc. For example, the apparatus 100 can be capable of connecting with a conference call or video conference at a remote conferencing server. The apparatus 100 can interface with a conferencing software (e.g., Microsoft Teams™, Skype™, Zoom™, Cisco Webex™). The wireless subsystems 105, 106, and 108 are each configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range. In embodiments, multiple mobile radio devices are connected to provide data connectivity and data sharing. In embodiments, the shared connectivity is used to establish a mesh network.

The position tracking component 125 and the position estimating component 123 operate in concert. The position tracking component 125 is used to track the location of the apparatus 100. In embodiments, the position tracking component 125 is a GNSS (e.g., GPS, Quasi-Zenith Satellite System (QZSS), BEIDOU, GALILEO, GLONASS) navigational device that receives information from satellites and determines a geographic position based on the received information. The position determined from the GNSS navigation device can be augmented with location estimates based on waves received from proximate devices. For example, the position tracking component 125 can determine a location of the apparatus 100 relative to one or more proximate devices using receives signal strength indicator (RSSI) techniques, time difference of arrival (TDOA) techniques, or any other appropriate techniques. The relative position can then be combined with the position of the proximate devices to determine a location estimate of the apparatus 100, which can be used to augment or replace other location estimates. In embodiments, a geographic position is determined at regular intervals (e.g., every five minutes, every minute, every five seconds), and the position in between readings is estimated using the position estimating component 123.

Position data is stored in memory 114 and uploaded to server at regular intervals (e.g., every five minutes, every minute, every five seconds). In embodiments, the intervals for recording and uploading position data are configurable. For example, if the apparatus 100 is stationary for a predetermined duration, the intervals are ignored or extended, and new location information is not stored or uploaded. If no connectivity exists for wirelessly communicating with a server, location data can be stored in memory 114 until connectivity is restored, at which time the data is uploaded and then deleted from memory 114. In embodiments, position data is used to determine latitude, longitude, altitude, speed, heading, and Greenwich mean time (GMT), for example, based on instructions of software 115 or based on external software (e.g., in connection with the server). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, the Bluetooth subsystem 108 receives signals from Bluetooth Low Energy (BLE) beacons located about the facility. The controller 110 is programmed to execute relational distancing software using beacon signals (e.g., triangulating between beacon distance information) to determine the position of the apparatus 100. Regardless of the process, the Bluetooth subsystem 108 detects the beacon signals and the controller 110 determines the distances used in estimating the location of the apparatus 100.

In alternative embodiments, the apparatus 100 uses Ultra-Wideband (UWB) technology with spaced-apart beacons for position tracking and estimation. The beacons are small, battery-powered sensors that are spaced apart in the facility and broadcast signals received by a UWB component included in the apparatus 100. A worker's position is monitored throughout the facility over time when the worker is carrying or wearing the apparatus 100. As described herein, location-sensing GNSS and estimating systems (e.g., the position tracking component 125 and the position estimating component 123) can be used to primarily determine a horizontal location. In embodiments, the barometer 111 is used to determine a height at which the apparatus 100 is located (or operates in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

In embodiments, the display 130 is a touch screen implemented using a liquid-crystal display (LCD), an e-ink display, an organic light-emitting diode (OLED), or other digital display capable of displaying text and images. In embodiments, the display 130 uses a low-power display technology, such as an e-ink display, for reduced power consumption. Images displayed using the display 130 include, but are not limited to, photographs, video, text, icons, symbols, flowcharts, instructions, cues, and warnings.

The audio device 146 optionally includes at least one microphone (not shown) and a speaker for receiving and transmitting audible sounds, respectively. Although only one audio device 146 is shown in the architecture drawing of FIG. 1, it should be understood that in an actual physical embodiment, multiple speakers or microphones can be utilized to enable the apparatus 100 to adequately receive and transmit audio. In embodiments, the speaker has an output around 105 dB to be loud enough to be heard by a worker in a noisy facility. The microphone of the audio device 146 receives the spoken sounds and transmits signals representative of the sounds to the controller 110 for processing.

The apparatus 100 can be a shared device that is assigned to a particular user temporarily (e.g., for a shift). In embodiments, the apparatus 100 communicates with a worker ID badge using near field communication (NFC) technology. In this way, a worker may log in to a profile (e.g., stored at a remote server) on the apparatus 100 through their worker ID badge. The worker's profile may store information related to the worker. Examples include name, employee or contractor serial number, login credentials, emergency contact(s), address, shifts, roles (e.g., crane operator), calendars, or any other professional or personal information. Moreover, the user, when logged in, can be associated with the apparatus 100. When another user logs in to the apparatus 100, however, that user can then be associated with the apparatus 100.

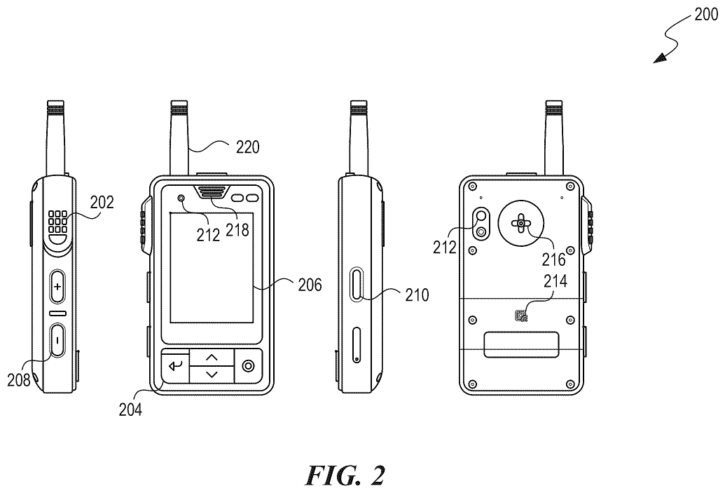

FIG. 2 is a drawing illustrating an example apparatus 200 for device communication and tracking, in accordance with one or more embodiments. The apparatus 200 includes a user interface that includes a PTT button 202, a 4-button user input system 204, a display 206, an easy to grab volume control 208, and a power button 210. The PTT button 202 can be used to control the transmission of data from or the reception of data by the apparatus 200. For example, the apparatus 200 may transmit audio data or other data when the PTT button 202 is pressed and receive audio data or other data when the PTT button 202 is released. In other examples, the PTT button 202 may control the transmission of audio data or other data from the apparatus 200 (e.g., transmit when the PTT button 202 is pressed), though apparatus 200 may transmit and receive audio data or other data at the same time (e.g., full duplex communication). The 4-button user input system 204 can be used to interact with the apparatus 200. For example, the 4-button user input system 204 can be used as a 4-direction input system (e.g., up-down-left-right), a 2-directional-enter-back (e.g., up-down-enter-back), or any other button configuration. The display 206 can output relevant visual information to the user. In aspects, the display 206 can enable touch input by the user to control the apparatus 200. The volume control 208 can control the loudness of the apparatus 200. The power button 210 can turn the apparatus 200 on and off.

The apparatus 200 further includes at least one camera 212, an NFC tag 214, a mount 216, at least one speaker 218, and at least one antenna 220. The camera 212 can be implemented as a front camera capturing the environment in front of the display 206 or a back camera capturing the environment opposite the display 206. The NFC tag 214 can be used to connect or register the apparatus 200. For example, the NFC tag 214 can register the apparatus 200 as being docked in a charging station. In yet another example, the NFC tag can connect to a worker's badge to associate the apparatus with the worker. The mount 216 can be used to attach the apparatus 200 to the worker (e.g., on a utility belt of the worker). The speaker 218 can output audio received by or presented on the apparatus 200. The volume of the speaker 218 can be controlled by the volume control 208. The antenna 220 can be used to transmit data from the apparatus 200 or receive data at the apparatus 200. In some cases, transmission or reception by the antenna 220 can be controlled by the PTT button 202 or another button of the user interface.

### Charging Station

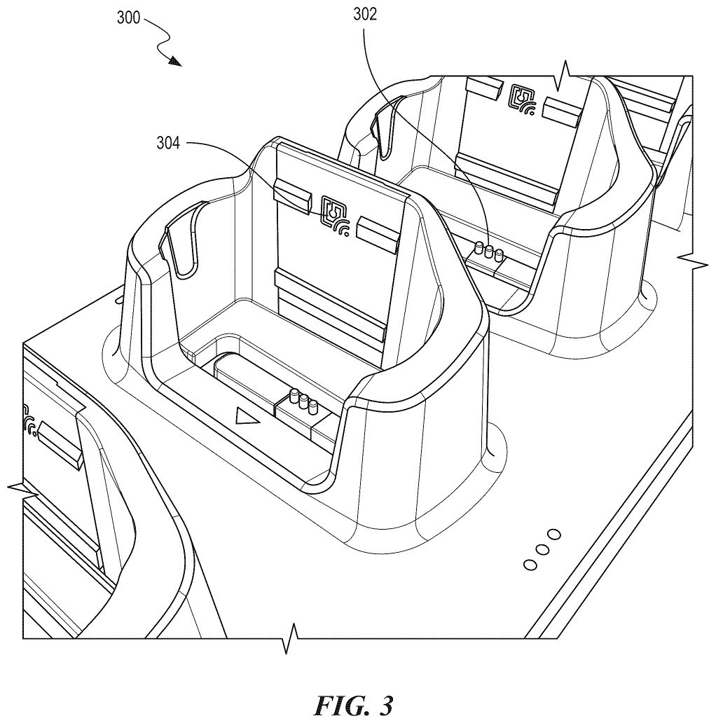

FIG. 3 is a drawing illustrating an example charging station 300 for apparatuses implementing device communication and tracking, in accordance with one or more embodiments. The charging station 300 can be used to dock one or more mobile radio devices for charging. In aspects, power can be supplied to the mobile radio devices docked at the charging station 300 through charging pins 302 located in each receptacle of the charging station 300. The charging pins 302 can be inserted into a charging port of the mobile radio devices. A worker clocking out at a facility can place a mobile radio device into the charging station 300. The mobile radio device can remain docked until it is removed from the charging station 300 by a worker clocking in at the facility.

The charging station 300 or the mobile radio device can determine when the mobile radio device has been docked in the charging station 300. For example, each receptacle of the charging station 300 can have an NFC pad 304 that connects with the mobile radio device when the mobile radio device is docked in that receptacle of the charging station 300. Alternatively or additionally, the mobile radio device can be determined to be docked in the charging station 300 when the charging pins 302 of a receptacle are inserted into the mobile radio device. In these ways, a cloud computing system can be made aware of the location and status (e.g., docked or removed) of the mobile radio device through communication with the charging station 300 or the mobile radio device.

### Communication Network

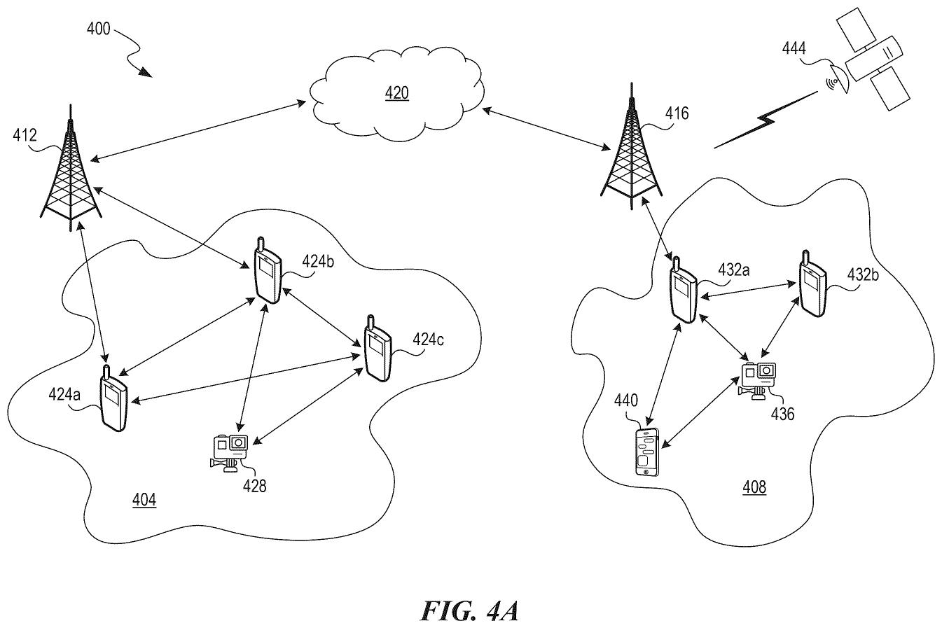

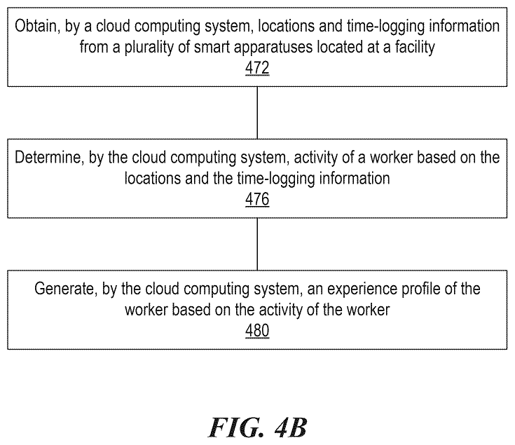

FIG. 4A is a drawing illustrating an example environment 400 for apparatuses and communication networks for device communication and tracking, in accordance with one or more embodiments. The environment 400 includes a cloud computing system 420, cellular transmission towers 412, 416, and local networks 404, 408. Components of the environment 400 are implemented using components of the example computer system illustrated and described in more detail with reference to subsequent figures. Likewise, different embodiments of the apparatus 100 include different and/or additional components and are connected in different ways.

Smart radios 424 (e.g., smart radios 424a-424c), smart radios 432 (e.g., smart radios 432a-b) and smart cameras 428, 436 are implemented in accordance with the architecture shown by FIG. 1. In embodiments, smart sensors implemented in accordance with the architecture shown by FIG. 1 are also connected to the local networks 404, 408 and mounted on a surface of a worksite, or worn or carried by workers. For example, the local network 404 is located at a first facility and the local network 408 is at a second facility. In embodiments, each smart radio and other smart apparatus has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 424a to connect to the local (e.g., cellular) network 404 and a second SIM card enables the smart radio 424a to connect to a commercial cellular tower (e.g., cellular transmission tower 412) for access to mobile telephony, the Internet, and the cloud computing system 420 (e.g., to major participating networks such as Verizon™, AT&T™, T-Mobile™, or Sprint™). In such embodiments, the smart radio 424a has two radio transceivers, one for each SIM card. In other embodiments, the smart radio 424a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM card becomes inactive until the first SIM card is no longer actively used.

In embodiments, the local network 404 uses a private address space of Internet protocol (IP) addresses. In other embodiments, the local network 404 is a local radio-based network using peer-to-peer (P2P) two-way radio (duplex communication) with extended range based on hops (e.g., from smart radio 424a to smart radio 424b to smart radio 424c). Hence, radio communication is transferred similarly to addressed packet-based data with packet switching by each smart radio or other smart apparatus on the path from source to destination. For example, each smart radio or other smart apparatus operates as a transmitter, receiver, or transceiver for the local network 404 to serve a facility. The smart apparatuses serve as multiple transmit/receive sites interconnected to achieve the range of coverage required by the facility. Further, the signals on the local networks 404, 408 are backhauled to a central switch for communication to the cellular transmission towers 412, 416.

In embodiments (e.g., in more remote locations), the local network 404 is implemented by sending radio signals between multiple smart radios 424. Such embodiments are implemented in less-inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 424a to other smart radios 424b, 424c on one or more frequency channels operating as a two-way radio. The radio messages sent include a header and a payload. Such broadcasting does not require a session or a connection between the devices. Data in the header is used by a receiving smart radio 424b to direct the “packet” to a destination (e.g., smart radio 424c). At the destination, the payload is extracted and played back by the smart radio 424c via the radio's speaker.

For example, the smart radio 424a broadcasts voice data using radio signals. Any other smart radio 424b within a range limit (e.g., 1 mile, 2 miles, etc.) receives the radio signals. The radio data includes a header having the destination of the message (smart radio 424c). The radio message is decrypted/decoded and played back on only the destination smart radio 424c. If another smart radio 424b that was not the destination radio receives the radio signals, the smart radio 424b rebroadcasts the radio signals rather than decoding and playing them back on a speaker. The smart radios 424 are thus used as signal repeaters. The advantages and benefits of the embodiments disclosed herein include extending the range of two-way radios or smart radios 424 by implementing radio hopping between the radios.

In embodiments, the local network 404 is implemented using Citizens Broadband Radio Service (CBRS). The use of CBRS Band 48 (from 3550 MHz to 3700 MHz), in embodiments, provides numerous advantages. For example, the use of CBRS Band 48 provides longer signal ranges and smoother handovers. The use of CBRS Band 48 supports numerous smart radios 424 and smart cameras 428 at the same time. A smart apparatus is therefore sometimes referred to as a Citizens Broadband Radio Service Device (CBSD).

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 404 is a private cellular (e.g., LTE) network operated specifically for the benefit of the facility. Only authorized users of the smart radios 424 have access to the local network 404. For example, the local network 404 uses the 900 MHz spectrum. In another example, the local network 404 uses 900 MHz for voice and narrowband data for Land Mobile Radio (LMR) communications, 900 MHz broadband for critical wide area, long-range data communications, and CBRS for ultra-fast coverage of smaller areas of the facility, such as substations, storage yards, and office spaces.

The smart radios 424 can communicate using other communication technologies, for example, Voice over IP (VOIP), Voice over Wi-Fi (VoWiFi), or Voice over Long-Term Evolution (VOLTE). The smart radios 424 can connect to a communication session (e.g., voice call, video call) for real-time communication with specific devices. The communication sessions can include devices within or outside of the local network 404 (e.g., in the local network 408). The communication sessions can be hosted on a private server (e.g., of the local network 404) or a remote server (e.g., accessible through the cloud computing system 420). In other aspects, the session can be P2P.

The cloud computing system 420 delivers computing services-including servers, storage, databases, networking, software, analytics, and intelligence-over the Internet to offer faster innovation, flexible resources, and economies of scale. FIG. 4A depicts an exemplary high-level, cloud-centered network environment 400 otherwise known as a cloud-based system. Referring to FIG. 4A, it can be seen that the environment centers around the cloud computing system 420 and the local networks 404, 408. Through the cloud computing system 420, multiple software systems are made to be accessible by multiple smart radios 424, 432, smart cameras 428, 436, as well as more standard devices (e.g., a smartphone 440 or a tablet) each equipped with local networking and cellular wireless capabilities. Each of the apparatuses 424, 428, 440, although diverse, can embody the architecture of the apparatus 100 shown by FIG. 1, but are distributed to different kinds of users or mounted on surfaces of the facility. For example, the smart radio 424a is worn by employees or independently contracted workers at a facility. The CBRS-equipped smartphone 440 is utilized by an on- or offsite supervisor. The smart camera 428 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radios 424, 432, smart cameras 428, 436, smartphone 440).

In embodiments, the cloud computing system 420 and local networks 404, 408 are configured to send communications to the smart radios 424, 432 or smart cameras 428, 436 based on analysis conducted by the cloud computing system 420. The communications enable the smart radio 424 or smart camera 428 to receive warnings, etc., generated as a result of analysis conducted. The employee-worn smart radio 424a (and possibly other devices including the architecture of the apparatus 100, such as the smart cameras 428, 436) is used along with the peripherals shown in FIG. 1 to accomplish a variety of objectives. For example, workers, in embodiments, are equipped with a Bluetooth-enabled gas-detection smart sensor. The smart sensor detects the existence of a dangerous gas, or gas level. By connecting through the smart radio 424a or directly to the local network 404, the readings from the smart sensor are analyzed by the cloud computing system 420 to implement a course of action due to sensed characteristics of toxicity. The cloud computing system 420 sends out an alert to the smart radio 424 or smart camera 428, and thus a worker, for example, uses a speaker or alternative notification means to alert other workers so that they can avoid danger.

### Position Estimation

The environment 400 can include one or more satellites 444. The smart radios 424 can receive signals from the satellites 444 that are usable to determine position estimates. For example, the smart radios 424 include a positioning system that implements a GNSS or other network triangulation/position system. In some embodiments, the locations of the smart radios 424 are determined from satellites, for example, GPS, QZSS, BEIDOU, GALILEO, and GLONASS. In some cases, the position determined from the primary positioning system does not satisfy a minimum accuracy requirement, the primary position can only be determined at predetermined intervals, or the primary position cannot be determined at all. Accordingly, additional positioning techniques can be used to augment or replace primary positioning. For example, the smart radio 424a can track its position based on broadcast signals received from proximate devices (e.g., using RSSI techniques or TDOA techniques). In some embodiments, the proximate devices include devices that have transmission ranges that encompass the location of the smart radio 424a (e.g., smart radios 424b, 424c). In some embodiments, the smart radios 424 determine or augment a secondary position estimate based on broadcasts received from a cellular communication tower (e.g., cellular transmission tower 412).

RSSI techniques include using the strength signals within a broadcast signal to determine the distance of a receiver from a transmitter. For instance, a receiver is enabled to determine the signal-to-noise ratio (SNR) of a received signal within a broadcast from a transmitter. The SNR of receive signal can be related to the distance between a receiver and a transmitter. Thus, the distance between the receiver and the transmitter can be estimated based on the SNR. By determining a receiver's distance from multiple transmitters, the receiver's position can be determined through localization (e.g., triangulation). In some cases, RSSI techniques become less accurate at larger distances. Accordingly, proximate devices may be required to be within a particular distance for RSSI techniques.

TDOA techniques include using the timing at which broadcast signals are received to determine the distance of a receiver from a transmitter. For example, a broadcast signal is sent by a transmitter at a known time (e.g., predetermined intervals). Thus, by determining the time at which the broadcast signal is received (e.g., using a clock), the travel time of the broadcast signal can be determined. The distance of the smart radios 424 from one another can thus be determined based on the wave speed. In some implementations, as broadcast signals are received from the transmitters, the smart radios 424 determine its relative position from each transmitter through localization, resulting in a more accurate global position (e.g., triangulation). Thus, TDOA techniques can be used to determine device location.

In aspects, the broadcast signals transmitted by proximate devices include information related to a position. For example, broadcast signals sent from the smart radios 424 identify their current location. Broadcast signals sent from cellular communication towers or other stationary devices may not need to include a current location, as the location may be known to the receiving device. In other cases, a cellular communication tower or other stationary device sends a broadcast signal that includes information indicative of a current location of the tower or stationary device. Using the current location of the transmitting devices and the location of the smart radios (e.g., smart radios 424b, 424c) relative to the transmitting devices, a global position of the smart radio 424a can be determined.

In some cases, a barometer is used to augment the position determination of the smart radios 424. For example, RSSI, TDOA, and other techniques are used to determine the distance between a transmitter and a receiver. However, these techniques may not provide information related to the displacement between the transmitter and the receiver (e.g., whether the distance is in the x, y, or z plane). In some cases, the barometer is used to provide relative displacement information (e.g., based on atmospheric conditions) of the smart radios 424. In aspects, the broadcast signals received from the proximate devices include information relating to respective elevation estimates (e.g., determined by barometers at the proximate devices) at each of the proximate devices. The elevation estimates from the proximate devices are compared to the elevation estimate of the smart radio 424a to determine the difference in elevation between the smart radio 424a and the proximate devices (e.g., smart radios 424b, 424c).

In some cases, a target device estimates a location based on proximate devices without analyzing broadcast signals. For example, proximate devices share their calculated location data. The target device (e.g., smart radio 424a) receives location data via any communication technology (e.g., Bluetooth or another short-range communication). One device (e.g., smart radio 424b) shares that it is at location A and another device (e.g., smart radio 424c) is at location B. The target device estimates that it's located somewhere near A and B (e.g., within a communication range of A and B using the respective communication mechanism). In another aspect, the target device receives location data from multiple proximate devices and combines (e.g., average) the location data to estimate its position. In yet another example, the target device receives location data from proximate devices via a first communication and uses a second communication to determine the location of the target device relative to the proximate devices. In this way, the location data need not be communicated in the same communication used to determine the relative location of the target device.

As an example, the smart radio 424b determines its location based on a primary location estimate that is augmented with a secondary location estimate. For example, the smart radio 424b receives a primary location estimate. In aspects, the primary location estimate is a GNSS location determined from the satellite 444 or a location estimate determined by communications with the cellular communication tower 412 (e.g., using TDOA, RSSI, or other techniques). In some implementations, the primary location estimate has a measurement error less than 1 foot, 2 feet, 5 feet, 10 feet, or the like. The measurement error may increase based on an environment of the smart radio 424b. For example, the measurement error may be higher if the smart radio 424b is within or surrounded by a densely constructed building.

To improve the measurement accuracy, the smart radio 424b can augment its primary location estimate based on a secondary location estimate. In aspects, the secondary location estimate is determined from broadcast signals transmitted by smart radio 424a, smart radio 424c, smart camera 428, cellular communication tower 412, or another communication device or node (e.g., an access point). Positioning techniques (e.g., TDOA, RSSI, location sharing, or other techniques) can be used to determine a relative distance from the transmitting device. For example, smart radio 424a, smart radio 424c, and smart camera 428 transmit broadcast signals that enable the distance of the smart radio 424b to be determined relative to each transmitting device. The transmitting devices can be stationary or moving. Stationary objects typically have strong or high confidence location data (e.g., immobile objects are plotted accurately to maps). The relative location of the smart radio 424b is determined through triangulation based on the distance from each transmitting device. In aspects, the secondary location estimate has a measurement error of less than 1 inch, 2 inches, 6 inches, or 1 foot. In aspects, the secondary location estimate replaces with the primary location estimate or is averaged with the primary location estimate to determine an augmented position estimate with reduced error. Accordingly, the measurement error of the location estimate of the smart device 424b can be improved by augmenting the primary location estimate with the secondary location estimate.

In some implementations, the location of the equipment is similarly monitored. In this context, mobile equipment refers to worksite or facility industrial equipment (e.g., heavy machinery, precision tools, construction vehicles). According to example embodiments, a location of a mobile equipment is continuously monitored based on repeated triangulation from multiple smart radios 424 located near the mobile equipment (e.g., using tags placed on the mobile equipment). Improvements to the operation and usage of the mobile equipment are made based on analyzing the locations of the mobile equipment throughout a facility or worksite. Locations of the mobile equipment are reported to owners of the mobile equipment or entities that own, operate, and/or maintain the mobile equipment. Mobile equipment whose location is tracked includes vehicles, tools used and shared by workers in different facility locations, toolkits and toolboxes, manufactured and/or packaged products, and/or the like. Generally, mobile equipment is movable between different locations within the facility or worksite at different points in time.

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels are indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. As another example, for a worker assigned with a maintenance task at a location within a facility, one or more maintenance toolkits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations.

### Machine-Defined Interactions

The cloud computing system 420 uses data received from the smart radios 424, 432 and smart cameras 428, 436 to track and monitor machine-defined activity of workers based on locations worked, times worked, analysis of video received from the smart cameras 428, 436, etc. The activity is measured by the cloud computing system 420 in terms of at least one of a start time, a duration of the activity, an end time, an identity (e.g., serial number, employee number, name, seniority level, etc.) of the worker performing the activity, an identity of the equipment(s) used by the worker, or a location of the activity. For example, a smart radio 424a carried or worn by a worker would track that the position of the smart radio 424a is in proximity to or coincides with a position of the particular machine.

The activity is measured by the cloud computing system 420 in terms of at least the location of the activity and one of a duration of the activity, an identity of the worker performing the activity, or an identity of the equipment(s) used by the worker. In embodiments, the ML system is used to detect and track activity, for example, by extracting features based on equipment types or manufacturing operation types as input data. For example, a smart sensor mounted on an oil rig transmits to and receives signals from a smart radio 424a carried or worn by a worker to log the time the worker spends at a portion of the oil rig.

Worker activity involving multiple workers can similarly be monitored. These activities can be measured by the cloud computing system 420 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. Group activities are detected and monitored using location tracking of multiple smart apparatuses. For example, the cloud computing system 420 tracks and records a specific group activity based on determining that two or more smart radios 424 were located in proximity to one another within a particular worksite for a predetermined period of time. For example, a smart radio 424a transmits to and receives signals from other smart radios 424b, 424c carried or worn by other workers to log the time the worker spends working together in a team with the other workers.

In embodiments, a smart camera 428 mounted at the worksite captures video of one or more workers working in the facility and performs facial recognition (e.g., using the ML system). The smart camera 428 can identify the equipment used to perform an activity or the tasks that a worker is performing. The smart camera 428 sends the location information to the cloud computing system 420 for generation of activity data. In embodiments, an ML system is used to detect and track activity (e.g., using features based on geographic locations or facility types as input data).

The cloud computing system 420 can determine various metrics for monitored workers based on the activity data. For example, the cloud computing system 420 can determine a response time for a worker. The response time refers to the time difference between receiving a call to report to a given task and the time of arriving at a geofence associated with the task. In aspects, the cloud computing system 420 can determine a repair metric, which measures the effectiveness of repairs by a worker, based on the activity data. For example, the effectiveness of repairs is machine observable based on a length of time a given object remains functional as compared to an expected time of functionality (e.g., a day, a few months, a year, etc.). In yet another aspect, the activity data can be analyzed to determine efficient routes to different areas of a worksite, for example, based on routes traveled by monitored workers. Activity data can be analyzed to determine the risk to which each worker is exposed, for example, based on how much time a worker spends in proximity to hazardous material or performing hazardous tasks. The ML system can analyze the various metrics to monitor workers or reduce risk.

### Worker Experience Profile

The cloud computing system 420 hosts the software functions to track activities to determine performance metrics and time spent at different tasks and with different equipment and to generate work experience profiles of frontline workers based on interfacing between software suites of the cloud computing system 420 and the smart radios 424, 432, smart cameras 428, 436, smartphone 440. Tracking of activities is implemented in, for example, Scheduling Systems (SS), Field Data Management (FDM) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.). Risk-Based Inspection (RBI) software assists the facility using optimized maintenance business processes to examine equipment and/or structures, and track activities prior to and after a breakdown in equipment, detection of manufacturing failures, or detection of operational hazards (e.g., detection of gas leaks in the facility). The amount of time each worker logs at a machine-defined activity with respect to different locations and different types of equipment is collected and used to update an “experience profile” of the worker on the cloud computing system 420 in real time.

FIG. 4B is a flow diagram illustrating an example process for generating a work experience profile using smart radios 424a, 424b, and local networks 404, 408 for device communication and tracking, in accordance with one or more embodiments. The smart radios 424 and local networks 404, 408 are illustrated and described in more detail with reference to FIG. 4A. In embodiments, the process of FIG. 4B is performed by the cloud computing system 420 illustrated and described in more detail with reference to FIG. 4A. In embodiments, the process of FIG. 4A is performed by a computer system, for example, the example computer system illustrated and described in more detail with reference to subsequent figures. Particular entities, for example, the smart radios 424 or the local network 404, perform some or all of the steps of the process in embodiments. Likewise, embodiments can include different and/or additional steps, or perform the steps in different orders.

In step 472, the cloud computing system 420 obtains locations and time-logging information from multiple smart apparatuses (e.g., smart radios 424) located at a facility. The locations describe movement of the multiple smart apparatuses with respect to the time-logging information. For example, the cloud computing system 420 keeps track of shifts, types of equipment, and locations worked by each worker, and uses the information to develop the experience profile automatically for the worker, including formatting services. When the worker joins an employer or otherwise signs up for the service, relevant personal information is obtained by the cloud computing system 420 to establish payroll and other known employment particulars. The worker uses a smart radio 424a to engage with the cloud computing system 420 and works shifts for different positions.

In step 476, the cloud computing system 420 determines activity of a worker based on the locations and the time-logging information. The activities describe work performed by one or more workers with equipment of the facility (e.g., lathes, lifts, crane, etc.). For example, the activities can include tasks performed by the worker, equipment worked with by the worker, time spent on a task or with a piece of equipment, or any other relevant information. In some cases, the activities can be used to log accidents that occur at the worksite. The activities can also include various performance metrics determined from the location and the time-logging information.

In step 480, the cloud computing system 420 generates the experience profile of the worker based on the activity of the worker. The cloud computing system 420 automatically fills in information determined from the activity of the worker to build the experience profile of the worker. The data filled into the field space of the experience profile can include the specific number of hours that a worker has spent working with a particular type of equipment (e.g., 200 hours spent driving forklifts, 150 hours spent operating a lathe, etc.). The experience profile can further include various performance metrics associated with a particular task or piece of equipment. In embodiments, the cloud computing system 420 exports or publishes the experience profile to a user profile of a social or professional networking platform (e.g., such as LinkedIn™, Monster™, any other suitable social media or proprietary website, or a combination thereof). In embodiments, the cloud computing system 420 exports the experience profile in the form of a recommendation letter or reference package to past or prospective employers. The experience data enables a given worker to prove that they have a certain amount of experience with a given equipment platform.

### Example Facility

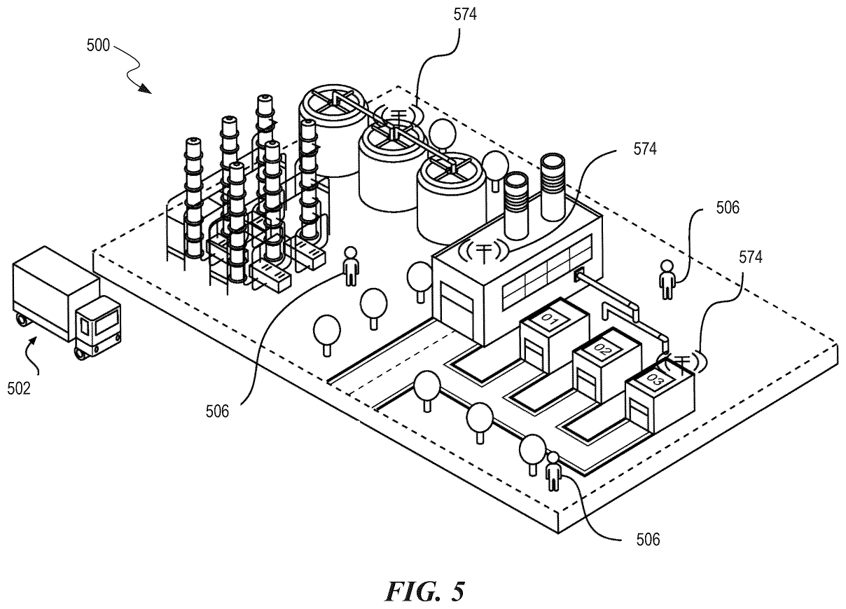

FIG. 5 is a drawing illustrating an example facility 500 using apparatuses and communication networks for device communication and tracking, in accordance with one or more embodiments. For example, the facility 500 is a refinery, a manufacturing facility, a construction site, etc. The communication technology shown by FIG. 5 can be implemented using components of the example computer systems illustrated and described in more detail with reference to the other figures herein.

Multiple differently and strategically placed wireless antennas 574 are used to receive signals from an Internet source (e.g., a fiber backhaul at the facility), or a mobile system (e.g., a truck 502). The truck 502, in embodiments, can implement an edge kit used to connect to the Internet. The strategically placed wireless antennas 574 repeat the signals received and sent from the edge kit such that a private cellular network is made available to multiple workers 506. Each worker carries or wears a cellular-enabled smart radio, implemented in accordance with the embodiments described herein. A position of the smart radio is continually tracked during a work shift.

In implementations, a stationary, temporary, or permanently installed cellular (e.g., LTE or 5G) source is used that obtains network access through a fiber or cable backhaul. In embodiments, a satellite or other Internet source is embodied into hand-carried or other mobile systems (e.g., a bag, box, or other portable arrangement). FIG. 5 shows that multiple wireless antennas 574 are installed at various locations throughout the facility. Where the edge kit is located at a location near a facility fiber backhaul, the communication system in the facility 500 uses multiple omnidirectional Multi-Band Outdoor (MBO) antennas as shown. Where the Internet source is instead located near an edge of the facility 500, as is often the case, the communication system uses one or more directional wireless antennas to improve the coverage in terms of bandwidth. Alternatively, where the edge kit is in a mobile vehicle, for example, truck 502, the antennas' directional configuration would be picked depending on whether the vehicle would ultimately be located at a central or boundary location.

In embodiments where a backhaul arrangement is installed at the facility 500, the edge kit is directly connected to an existing fiber router, cable router, or any other source of Internet at the facility. In embodiments, the wireless antennas 574 are deployed at a location in which the smart radio is to be used. For example, the wireless antennas 574 are omnidirectional, directional, or semidirectional depending on the intended coverage area. In embodiments, the wireless antennas 574 support a local cellular network. In embodiments, the local network is a private LTE network (e.g., based on 4G or 5G). In more specific embodiments, the network is a CBRS Band 48 local network. The frequency range for CBRS Band 48 extends from 3550 MHz to 3700 MHZ and is executed using TDD as the duplex mode. The private LTE wireless communication device is configured to operate in the private network created, for example, to accommodate CBRS Band 48 in the frequency range for Band 48 (again, from 3550 MHz to 3700 MHZ) and accommodates TDD. Thus, channels within the preferred range are used for different types of communications between the cloud and the local network.

### Geofencing

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices that inform of the location of the smart radio at various times. Embodiments described herein relate to location-based features for smart radios or smart apparatuses. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

Some example scenarios that require radio communication between workers are area-specific, or relevant to a given area of a facility. For example, when machines need repair, workers near the machine can be notified and provided instructions to assist in the repair. Alternatively, if a hazard is present at the facility, workers near the hazard can be notified.

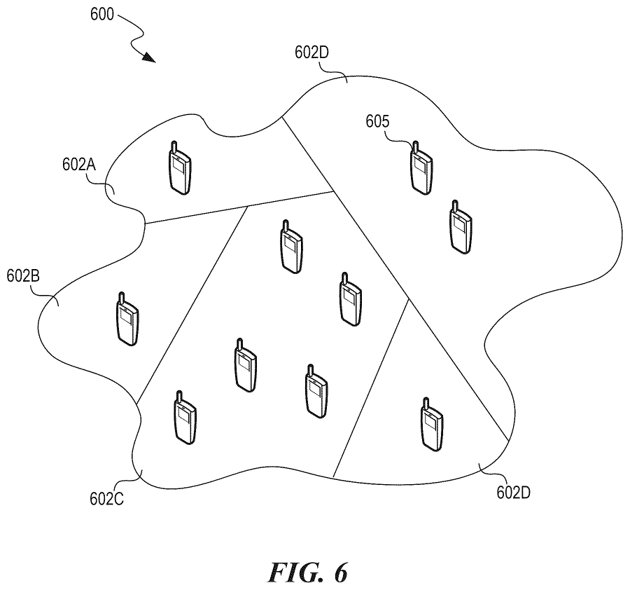

According to some embodiments, locations of smart radios are monitored such that at a point in time, each smart radio located in a specific geofenced area is identified. FIG. 6 illustrates an example of a worksite 600 that includes a plurality of geofenced areas 602, with smart radios 605 being located within the geofenced areas 602.

In some embodiments, an alert, notification, communication, and/or the like is transmitted to each smart radio 605 that is located within a geofenced area 602 (e.g., 602C) responsive to a selection or indication of the geofenced area 602. A smart radio 605, an administrator smart radio (e.g., a smart radio assigned to an administrator), or the cloud computing system is configured to enable user selection of one of the pluralities of geofenced areas 602 (e.g., 602C). For example, a map display of the worksite 600 and the plurality of geofenced areas 602 is provided. With the user selection of a geofenced area 602 and a location for each smart radio 605, a set of smart radios 605 located within the geofenced area 602 is identified. An alert, notification, communication, and/or the like is then transmitted to the identified smart radios 605.

### ML System

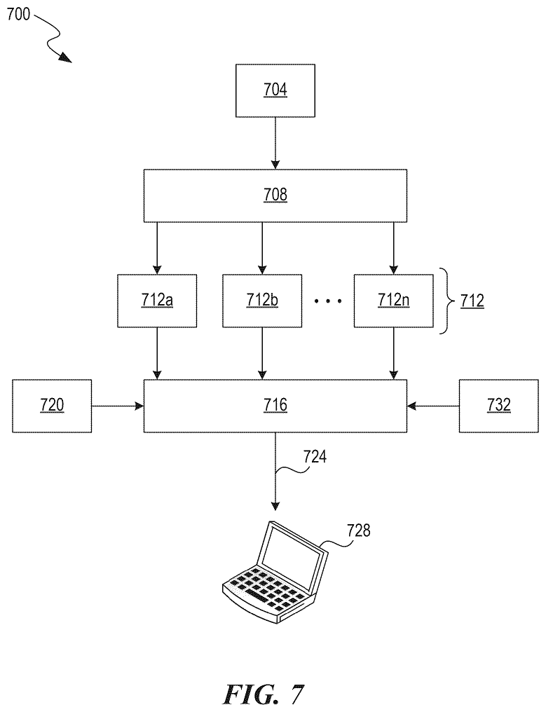

FIG. 7 is a block diagram illustrating an example ML system 700, in accordance with one or more embodiments. The ML system 700 can implement one or more components of the computer systems and apparatuses discussed herein. Although illustrated in a particular configuration, different embodiments of the ML system 700 include different and/or additional components and are connected in different ways. The ML system 700 is sometimes referred to as an ML module.

The ML system 700 includes a feature extraction module 708 implemented using components of an example computer system, as described herein. In some embodiments, the feature extraction module 708 extracts a feature vector 712 from input data 704. The feature vector 712 includes features 712a, 712b, . . . , 712n. The feature extraction module 708 reduces the redundancy in the input data 704, for example, repetitive data values, to transform the input data 704 into the reduced set of features 712, for example, features 712a, 712b, . . . , 712n. The feature vector 712 contains the relevant information from the input data 704, such that events or data value thresholds of interest are identified by the ML model 716 by using a reduced representation. In some example embodiments, the following dimensionality reduction techniques are used by the feature extraction module 708: independent component analysis, Isomap, principal component analysis (PCA), latent semantic analysis, partial least squares, kernel PCA, multifactor dimensionality reduction, nonlinear dimensionality reduction, multilinear PCA, multilinear subspace learning, semidefinite embedding, autoencoder, and deep feature synthesis.

In alternate embodiments, the ML model 716 performs deep learning (also known as deep structured learning or hierarchical learning) directly on the input data 704 to learn data representations, as opposed to using task-specific algorithms. In deep learning, no explicit feature extraction is performed; the features 712 are implicitly extracted by the ML system 700. For example, the ML model 716 uses a cascade of multiple layers of nonlinear processing units for implicit feature extraction and transformation. Each successive layer uses the output from the previous layer as input. The ML model 716 thus learns in supervised (e.g., classification) and/or unsupervised (e.g., pattern analysis) modes. The ML model 716 learns multiple levels of representations that correspond to different levels of abstraction, wherein the different levels form a hierarchy of concepts. The multiple levels of representation configure the ML model 716 to differentiate features of interest from background features.

In alternative example embodiments, the ML model 716, for example, in the form of a convolutional neural network (CNN), generates the output 724, without the need for feature extraction, directly from the input data 704. The output 724 is provided to the computer device 728. The computer device 728 is a server, computer, tablet, smartphone, smart speaker, etc., implemented using components of an example computer system, as described herein. In some embodiments, the steps performed by the ML system 700 are stored in memory on the computer device 728 for execution. In other embodiments, the output 724 is displayed on an apparatus or electronic displays of a cloud computing system.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 716 is a CNN that includes both convolutional layers and max pooling layers. For example, the architecture of the ML model 716 is “fully convolutional,” which means that variable sized sensor data vectors are fed into it. For convolutional layers, the ML model 716 specifies a kernel size, a stride of the convolution, and an amount of zero padding applied to the input of that layer. For the pooling layers, the ML model 716 specifies the kernel size and stride of the pooling.

In some embodiments, the ML system 700 trains the ML model 716, based on the training data 720, to correlate the feature vector 712 to expected outputs in the training data 720. As part of the training of the ML model 716, the ML system 700 forms a training set of features and training labels by identifying a positive training set of features that have been determined to have a desired property in question, and, in some embodiments, forms a negative training set of features that lack the property in question.

The ML system 700 applies ML techniques to train the ML model 716, such that when applied to the feature vector 712, output indications of whether the feature vector 712 has an associated desired property or properties, such as a probability that the feature vector 712 has a particular Boolean property, or an estimated value of a scalar property. In embodiments, the ML system 700 further applies dimensionality reduction (e.g., via linear discriminant analysis (LDA), PCA, or the like) to reduce the amount of data in the feature vector 712 to a smaller, more representative set of data.

In embodiments, the ML system 700 uses supervised ML to train the ML model 716, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 732 is formed of additional features, other than those in the training data 720, which have already been determined to have or to lack the property in question. The ML system 700 applies the trained ML model 716 to the features of the validation set 732 to quantify the accuracy of the ML model 716. Common metrics applied in accuracy measurement include Precision and Recall, where Precision refers to a number of results the ML model 716 correctly predicted out of the total it predicted, and Recall is a number of results the ML model 716 correctly predicted out of the total number of features that had the desired property in question. In some embodiments, the ML system 700 iteratively retrains the ML model 716 until the occurrence of a stopping condition, such as the accuracy measurement indication that the ML model 716 is sufficiently accurate, or a number of training rounds having taken place. In embodiments, the validation set 732 includes data corresponding to confirmed locations, dates, times, activities, or combinations thereof. This allows the detected values to be validated using the validation set 732. The validation set 732 is generated based on the analysis to be performed.

### Worker Engagement and Safety

A frontline worker can have a siloed role at a facility even in the presence of other workers. For example, workers on an assembly line are physically proximate to one another but are tasked to handle distinct jobs that do not require communications or engagement with each other. The lack of engagement can make the work unenjoyable, which increases attrition and creates inefficiencies to replace workers. Existing solutions to improve engagement can include communications devices to share communications among a team, along with messaging platforms on those devices that facilitate communications and gamify engagement from workers with the apps. These existing engagement solutions are ineffective because they fail to create a community among workers at a facility to promote real-world engagement. Moreover, existing engagement solutions are gimmicky and the experience they provide is unnatural.

Audio for entertainment purposes that is rendered on smart radio devices to workers is typically prohibited or undesired due to safety concerns. In other words, playback of music on smart radio devices used by frontline workers is considered unsafe because the music can distract the workers from performing their work, which can involve operating complex or dangerous machinery. For example, an operator that has unrestricted control over the playback of music can control the volume and interactions with the music service such that the operator gets distracted and lacks awareness of their surroundings. Moreover, playback of the music at a high volume poses a health and safety risk because, for example, 85 dB is the maximum recommended exposure limit for human hearing. Moreover, free access to a music service can violate state or federal safety standards.

Work environments require varying degrees of safety measures including providing notifications and ongoing trainings to workers. Spoken natural language remains a core and effective means for communicating notifications and trainings. However, given the diversity of frontline workers who speak in different languages, keeping workers informed in a timely manner to promote engagement and ensure safety remains challenging. The disclosed technology addresses these drawbacks by promoting engagement of workers with administrative personnel and with other workers through music on smart radios. In particular, music channels provide for simulcasting music to multiple users of radio devices, which increases engagement in a work environment. The music channels have a dual function of also hosting supplemental audio that is delivered to the users. Moreover, the music channel is controlled by the platform to ensure that the music does not pose a safety hazard by controlling volume and playback.

More specifically, the ability to play music on smart radio devices carried by frontline workers increases the likelihood that the workers will utilize their smart radio devices for audio purposes, which presents an opportunity to interrupt or overlay music with safety notifications. Furthermore, safety notifications can be translated into the native language of the user of the smart radio. For example, an English-speaking worker can receive a safety message spoken in English while a Spanish-speaking worker can receive the same safety message at virtually the same time but spoken in Spanish.

The music service can include a variety of music channels that can be selected on the smart radios by the workers. As such, the workers can control the music channels that they select. Examples of music channels include rock, pop, country, hip hop, among others. Once a user selects a music channel, the smart radio device can stream the music from a source that controls the music content, through a platform that controls music playback. In particular, the platform hosts the smart radio devices and, as such, the platform controls playback of the music on the smart radio devices (e.g., how and when the music is rendered). In particular, the platform dynamically controls a user's experience in a location of a facility hosted by the platform. That is, the platform hosting the facility controls music as part of a workflow that can be dependent on the facility, the individual worker, a schedule, and the location of the worker and objects around the worker.

The playback of music can respond to actions that are performed by the user, that occur in proximity to the user, or that can impact the performance or safety of the user or other workers in the environment. For example, the platform can cause the music channel to pause in response to the presence of people or devices or in particular locations. In one example, the platform can cause a smart radio to mute or pause when the smart radio detects or recognizes a voice of the user or another worker speaking to the user. The platform can use the smart radio device to track the user though a workflow that dynamically adapts playback of the music to reduce the risk of hazards. The platform can also control playback of on a smart radio device to induce an action by the user. For example, the volume and audio can induce the user to react by changing location or starting/stopping a particular task. In one example, a warning can include stopping playback of music, increasing the volume of the audio, and generating siren sounds.

The smart radio device hosts a secondary app that is controlled by a primary app, which is controlled by the host of smart radios devices at a facility. As such, the primary app can operate like an operating system. The smart radio device can use proximity peer-to-peer communications to inform the user of, for example, how a forklift if moving relative to the user. That is, a first user that has a smart radio device can be notified that a second smart radio device of a second user operating a forklift is on a collision course to the first user. Further, the second smart radio device can use its sensor to determine that the second user is operating the forklift instead of, for example, walking. For example, the radio devices can include motion sensors (e.g., magnetometers, accelerometers) that can detect movements indicative of a forklift. As such, a smart radio can distinguish between one worker approaching another and a forklift approaching a worker.

### Music on Radio Architecture

The smart radio can host management software or have an operating system (OS) that manages access to channels of the music service. In one example, the OS of a smart radio device is specifically designed so that the platform can control playback of music at the smart radio device. That is, the smart radio device operates under the control of the platform to manage playback of the music while allowing the user to select a music channel for playback.

In another implementation, the music service is controlled by a management app hosted on a smart device, where the management app is part of a management system such as a mobile device management (MDM) system. An MDM can be implemented with the use of a third-party product that has management features for particular vendors of mobile devices. The MDM can be a deployment of a combination of on-device applications and configurations, policies and certificates, and backend infrastructure, for the purpose of simplifying and enhancing the IT management of smart devices.

The disclosed technology can include MDM services that control the playback of music on smart devices as part of workflows for users of the smart devices. The MDM functionality can include over-the-air distribution of applications, data and configuration settings for different types of mobile devices, including smart radios, smartphones, tablet computers, ruggedized mobile computers, etc. The MDM tools can be leveraged for both company-owned and employee-owned (BYOD) devices across the enterprise or mobile devices owned by consumers. By controlling and protecting the data and configuration settings of all mobile devices in a network, the MDM can control playback of music to engage workers while optimizing security.

In one implementation, the platform is hosted on a server component, which sends out the management commands to control the mobile devices, and a client component, which runs on the managed device and receives and implements the management commands to control playback of music. In some cases, a single vendor provides both the client and the server, while in other cases the client and server are from different sources. As such, the MDM allows control by the platform over the smart device including functions other than the app that provides the music service. For example, the MDM allows the platform to control outputs (e.g., volume) of the phone.

In another implementation, a mobile application management (MAM) is used, which has more limited capabilities to control a smart device compared to an MDM. The MAM is software that secures and enables control over enterprise applications on smart devices. MAM software allows administrators to apply and enforce policies on mobile apps and limit the sharing of data among apps. The MAM also enables the separation of business apps and data from personal content on the same device. Other MAM features and capabilities include software delivery (e.g., through an enterprise app store), software license management, app configuration, inventory management, and application lifecycle management.

The MAM allows administrators to apply and enforce policies only on specified apps that access certain data like streaming music, leaving personal apps and data untouched. Some of MAM's functionality is similar to MDM. For example, with MAM, IT can remote wipe an app but not the entire device, as is the case with an MDM-managed device, for example. In some implementations, the smart devices include the MDM and MAM to manage the music service.

### Synchronized Audio Service

A smart radio device provides a user access to the music service. For example, a touch-sensitive interface can present a graphical control, or the smart radio can have a hardware button that, when actuated, presents options for selecting music channels (e.g., music stations). The smart radio accesses the music channel via an application programming interface (API) of the music service provider. The access to the API is controlled by the platform that hosts smart radios for a facility. As such, the platform controls a smart radio's access to a music channel. Accordingly, the platform can stop/start streaming or interrupt the music to present audio from another source. In another example, the platform can blend audio from the other source to overlay the music. As such, for example, the platform can interrupt or overlay playback of the music to present a safety warning or notification that provides situational awareness to the user. That is, the platform controls how the music will be rendered by the smart radio device. In another implementation, the platform can control how the smart radio renders the music without interrupting the music channel. For example, the platform can control the output of the smart radio to stop/start or interrupt sound generated by the smart radio without interrupting the music streaming to the smart radio device. In yet another implementation, a smart radio device provides local control over playback of music. For example, the smart radio device can stop software from rendering music or mute/attenuate a music channel to present a safety notification.

The music service that is controlled by the platform can be provided to smart radios by using different communications technology. Generally, the audio service administers one or more audio streams (e.g., media such as music) that is delivered synchronously to multiple smart radios such that users have a shared music experience.

An encoded audio stream can include a series of key frames and prediction frames. A key frame can represent a full frame of the media. In operation, a smart radio device can process a first key frame to render the corresponding media content. Key frames can be decoded without reference to any other frame in a sequence, where the decoder reconstructs such frames beginning from the decoder's “default” state. The prediction frames succeed the key frame and represent differences between the key frame, which can lower the required data to render the frame represented by the predicted frame. In many cases, the correct decoding of a predictive frame depends on the correct decoding of the most recent key frame and all ensuing predictive frames.

A media stream can be encoded using an encoding technique, such as chunked transfer encoding to create chunks (i.e., divided and non-overlapping portions of the media stream). Chunks of encoded media stream can be transmitted and received independently of one another. In some embodiments, both the recipient and the sender of the chunk-based stream may not need to know of the data stream outside of the chunk currently being processed.

The disclosed technology can enable adaptive bitrate streaming with multiple subscribers to the same music channel. As an example, radio A can subscribe to the encoded media stream at time TO. Radio B can subscribe at time T1. In some embodiments, if the encoded stream utilizes adaptive bitrate streaming, each distribution layer of the stream can previously be encoded. A new radio (e.g., radio B) subscribing to the already broadcasting encoded stream requests a new key frame at a specific resolution. In many cases, the radio B can request the encoded media stream at a subscription time before the arrival of a new key frame at time T2 in relation to the time domain.

In response to changing network conditions, a smart radio device can request changing the bitrate of an encoded media stream to adapt to the changing network conditions. However, to subscribe to another distribution layer, the radio device may have to wait until a new key frame for the requested distribution layer arrives. Accordingly, the duration between the first time and the second time represents a time duration where bandwidth is underutilized.

### Geofencing

A smart radio device can be configured to perform an action that manages a music service in response to a smart radio device approaching or passing a geofenced region. For example, the disclosed technology can determine the location of a smart radio device and respond as the smart radio device that approaches or leaves a geofenced area. In particular, the system can implement rules that respond to a smart radio device leaving or approaching a geofenced area. For example, the volume can be controlled to lower or raise in response to the location of the smart radio device being near a geofenced area. The system can detect the location of the smart radio device to be inside or outside of a geofenced area and respond accordingly.

The platform can host different facilities that each implement policies (e.g., including rulesets) that depends on the type of facility. As such, the platform can implement different rulesets for different facilities. In one example, a first facility where workers primarily operate sewing machines might implement a less restrictive ruleset compared to a second facility that assembles automobiles. The ruleset for the first facility can allow users control over access to the music service and the way in which music is rendered (e.g., volume control). In contrast, the ruleset for the second facility could deny users any control over volume. That is, the volume for any particular smart device within the facility would be controlled by the platform that hosts the ruleset for the facility.

The platform that hosts the different facilities can partition an area of a particular facility into zones that are defined with geofencing. As such, the platform can implement different rulesets for different zones. In one example, a facility can have different zone types of varying risk or safety levels such as high, medium, or low. The facility can have distinct areas that are designated at one level and other areas that are designated at other levels. For example, an area in which there is dangerous machinery used to assemble products can be designated as “high risk” while the lunchroom area can be designated as “low risk.” The ruleset for the high-risk zone can remove certain local controls from a smart radio device compared to the low-risk zone. As such, a smart radio can dynamically adapt to manage a workflow that implements different rulesets in different zones as an operator of the smart radio travels throughout the facility. For example, the platform can limit the volume to a maximum of 85 dB throughout the facility, fix the volume to a particular level in the high-risk zone, and allow the user to manually control the volume when they enter the lunchroom.

### Proximate Device Detection

The system can modify playback of audio (e.g., music stream) at a smart radio device based on its location relative to the location of another device. That is, a smart radio device that is rendering audio can respond to the relative location of another smart radio device and/or another type of device or machine. For example, a first smart radio device can recognize the presence of a second smart radio device and respond by, for example, changing a parameter of playback on the first smart radio device. In one example, the first smart radio device can detect that the second smart radio device is approaching and, in response, stop playback or reduce the volume of playback temporarily. As such, the first smart radio device anticipates that a user of the second smart radio device is approaching to potentially engage in a verbal dialog that would require attention. By stopping playback or attenuating the sound, a user is not only notified of the approaching coworker but also can hear what the coworker might say. The first smart radio device can respond similarly to its user approaching the second smart radio device. In other words, a smart radio device can respond to the presence of another smart radio device, as well as the changing distance between the two.

A smart radio device can also respond to a device other than another smart radio device. As such, the smart radio device can respond to the presence of a machine or an IoT device equipped to send a signal that can be detected by the smart radio device as an indication of the presence of the machine or device. For example, a forklift that is equipped with an emitter indicative of its presence can be detected by a smart radio device to avoid a hazard of the operator being hurt by the forklift.

### Loudspeaker-Type Dependent Controls

The configuration of music service that is available to a user of a smart radio device can depend on the type of loudspeaker device that the user connects to the smart radio device. Types of loudspeaker devices include over-ear headphones, on-ear headphones, earbuds, noise-canceling headphones, bone conduction headphones, boom mics, standalone speakers, speakers integrated in smart radio devices, etc. The smart radio device can connect to the loudspeaker device wirelessly or a wired means to generate sound from the smart radio device.

Once a user of a smart radio device connects a loudspeaker, the smart radio can detect the type of speaker using a variety of known methods and implement policies that is specific for the type of loudspeaker. For example, the policies for a boom mic might have a higher threshold maximum permitted volume compared to policies for an over-ear headphone. Certain rules of policies can be implemented depending on the capabilities of the particular type of loudspeaker. For example, the smart radio device can detect that a particular type of headphone has a noise canceling feature and, in response, implement a rule to disable or enable noise canceling in response to the presence of a device or to the user being in a particular zone.

### Automatic User Customization

The system can be controlled by the platform to customize the experience and safety features for specific users. That is, the smart radio can adapt to a user's specific needs, condition, or situation. For example, content delivered to the user of a smart device, distinct from a music stream, can be configured for that user. Examples include notifications that are delivered in a language that is native to the user or additional content for users that are newer to a job and require additional feedback. As such, content can be delivered to train a user depending on the user's experience level.

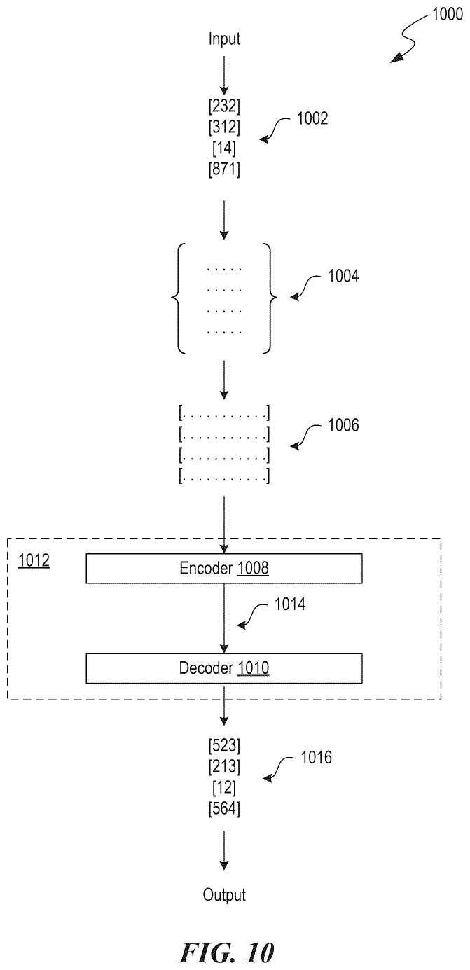

The disclosed technology can implement a generative artificial intelligence (genAI) system to create content that us customized for a user. A technical description of the genAI system is described with respect to FIG. 10. The generated content can include safety messages including language conversion of notifications that overlay music. For example, a genAI system can be trained based on model data of a type of facility and include profiles of workers having specific roles for that facility. For example, a first model can be trained for an oil and gas plant and a second model can be trained for a food packing plant. The models can include data about the types of machines in devices found in the facility, as well as the roles and workflows of workers in the facilities. The model can be trained to output content that us customized for user based on input including sensor data from the smart radio device. For example, a smart radio device can detect an approaching device aboard a forklift and generate an audio message such as “forklift approaching behind you,” which is overlayed into the music being played as notification. As such, the music on the smart radio device can engage the worker and the genAI platform can customize the notifications to a user of the smart radio device, to improve the situational awareness of the user.

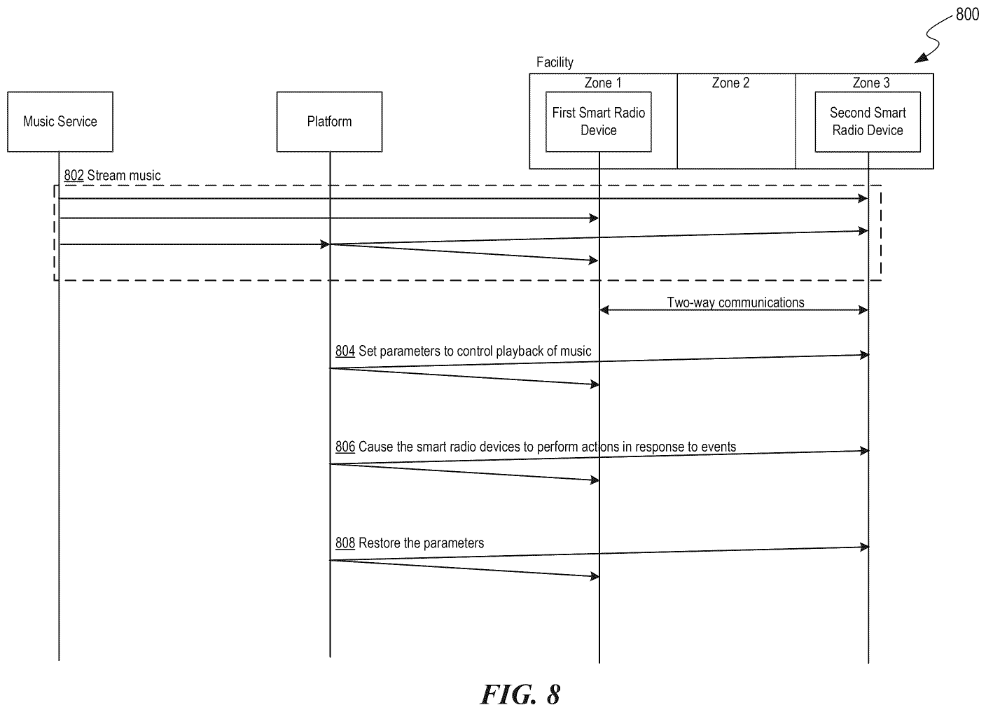

FIG. 8 is a diagram that illustrates a process 800 for controlling playback of music at smart radio devices. The process can be performed by a server system that hosts a platform that controls the smart radio devices. For example, a smart radio device can be configured to host a mobile app that enables the user of the smart radio device to select the music channel from among multiple available music channels for playback through the loudspeaker coupled to the smart radio device.

Referring back to FIG. 8, At 802, the platform enables users of smart radio devices to select music channels for playback through loudspeakers coupled to the smart radio devices. Each smart radio is configured for two-way communication and belongs to a group of smart radio devices associated with a facility. The platform can enable simulcast of a first music of a first music channel across a first subset of smart radio devices of the group of smart radio devices. The platform can also enable simulcast of a second music of a second music channel across a second subset of smart radio devices different from the first subset. The platform can cause the first subset to present a first indication that each smart radio belongs to the first subset and cause the second subset of smart radio devices to present a second indication different than the first. For example, the first indication can be LED lights that emit one color or pattern of light and the second indication can be LED lights that emit another color or another pattern of light. The indications can be anything perceivable to people who are not users of any of the group of smart radio devices.

At 804, the platform sets one or more parameter(s) for playback of music at the smart radio device in accordance with one or more rule(s) that is implemented for the facility. In one example, the rule(s) is a ruleset selected from among multiple rulesets for a type of loudspeaker corresponding to over-ear headphones, on-ear headphones, earbuds, noise-canceling headphones, bone conduction headphones, boom mics, standalone speakers, or speakers integrated in smart radio devices. The platform can dynamically control parameter(s) of playback of the music responsive to a workflow including presence of the user in geofenced locations of the facility and presence of devices in a threshold proximity to the smart radio device. The parameter(s) are controlled by the platform hosted on the server system via an operating system, mobile device management app, or mobile application management app that is hosted on the smart radio device.

At 806, the platform causes the smart radio device to respond to an event detected at the smart radio device by performing an action. The event is based on a location of the smart radio device relative to a geofenced area (e.g., zones 1, 2, 3) of the facility or presence of a device, equipment, or machine in a threshold vicinity of the smart radio device. Performing the action includes modifying a value of the parameter(s) of playback of music.

At 808, the platform optionally causes the smart radio device to restore the value of the parameter(s) of playback of music in response to detecting that the event ended or after expiration of a time period that began when the event was detected. In one example, performing the action includes causing the smart radio device to interrupt playback of the music on the music channel for a time period and instead playback an audio notification during the time period. In another example, performing the action includes causing the smart radio to attenuate volume of the music on the music channel for a time period and playback an audio notification during the time period to overlay the attenuated music. In another example, performing the action includes attenuating the volume of the music for a time period and playback an audio notification during the time period to overlay the attenuated music.

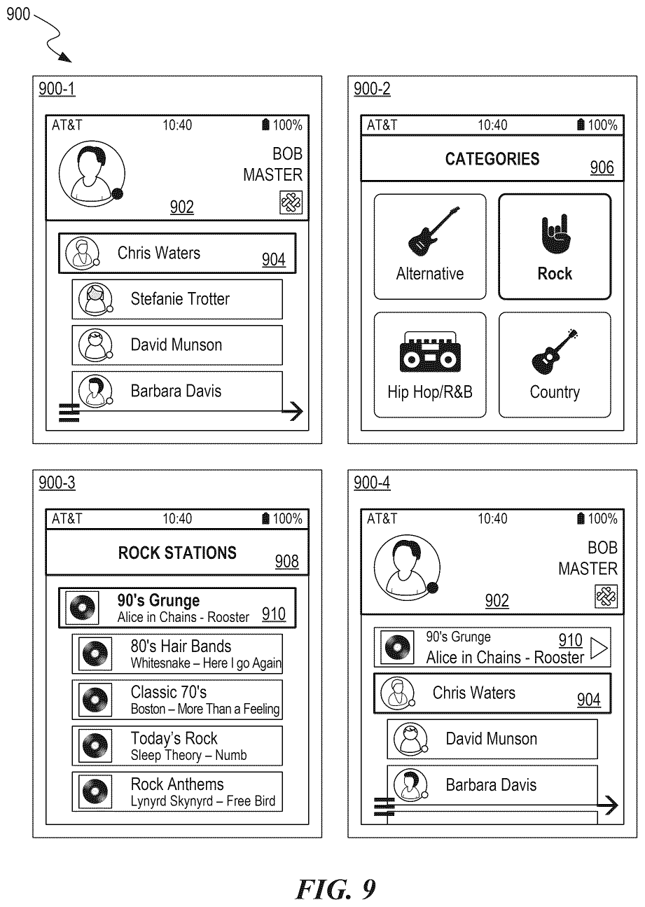

FIG. 9 illustrates an interface 900 on a smart radio device used to access the music service. The interface 900 can display varying views such as 900-1, 900-2, 900-3, and 900-4. Each view is associated with distinct features that are displayed on the smart radio device as the user navigates the music service.

The view 900-1 of the interface 900 includes a link to a smart radio device user's profile along with a link associated with the user's contacts. Where the links of graphical buttons direct users to their information and information of their contacts. The smart radio devices connect users working within the same facility based on their user profile 902 to increase engagement. For example, user profile 902 (e.g., Bob Master) can connect with contact 904 (e.g., Chris Waters) by selecting the smart radio device's graphical button that is linked to the user's contacts. The connection feature enhances collaboration and communication among frontline workers to ensure the smart radio device's user remains engaged and accessible to other smart radio device users.

The view 900-2 of the interface 900 displays the different categories 906 of music genre that are available to stream to a smart radio device. The categories 906 can include various genres such as alternative, rock, hip hop, country, and more. At the view 900-2 of the interface 900, the smart radio device's user can select their preferred type of music, thereby personalizing their listening experience. The platform can manage the user selections from the categories 906 and ensure that the music played is synchronized across different groups of smart radio devices within the facility.

The view 900-3 of the interface 900 displays the music station 908 header that indicates the music genre the user selected from the categories 906 options displayed in the previous view 900-2. The view 900-3 further provides the different music channels based on musical eras that can be selected by the user. For example, music channel 910 provides the user with the option to listen to rock music from various musical eras such as modern, 90's, 80's, 70's, and more. The view 900-3 of the interface 900 displays the user selected music channel 910 (e.g., 90's grunge rock) and shows the artist (e.g., Alice in Chains) along with the song (e.g., Rooster) to the user. At view 900-3 of the interface 900, the user can further explore their selected genre and choose specific channels that cater to their musical preferences.

A view 900-4 of the interface 900 displays various feature combinations that were shown in prior views (e.g., 900-1, 900-2, and 900-3). At the view 900-4 of the interface 900, the user can view their user profile 902 along with the currently selected music channel 910 that is playing via the smart radio device loudspeaker. The user can view which contact is listening to the same music channel. For example, as shown, the as the user profile 902 (e.g., Bob Masters) can view that contact 904 (e.g., Chris Walters) is also listening to the same music channel 910 (e.g., 90's Grunge) because the graphical button of contact 904 (e.g., Chris Waters) is highlighted and enlarged when compared to the other contacts (e.g., David Munson and Barbara Davis). The view 900-4 of the interface 900 integrates multiple functionalities that provide a comprehensive view of the user's music experience and their social connections within the facility.

In another example, performing the action includes causing the smart radio device to select an audio notification for playback during or instead of the music being rendered on the smart radio device, translating the audio notification into a preferred language of the user as indicated in a profile of the user, and playing back an audio notification to interrupt or overlay the music. In yet another example, performing the action includes causing the smart radio device to generate, based on a genAI system, an audio notification for playback during or instead of the music being rendered on the smart radio device. The audio notification is generated based on a profile of the user and a profile of the facility, for example.

FIG. 10 is a block diagram of an example transformer 1012. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 1012 includes an encoder 1008 (which can include one or more encoder layers/blocks connected in series) and a decoder 1010 (which can include one or more decoder layers/blocks connected in series). Generally, the encoder 1008 and the decoder 1010 each include multiple neural network layers, at least one of which can be a self-attention layer. The parameters of the neural network layers can be referred to as the parameters of the language model.

The transformer 1012 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 1012 is trained to perform certain functions on other input formats than natural language input. For example, the input can include objects, images, audio content, or video content, or a combination thereof.

The transformer 1012 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 10 illustrates an example 1000 of how the transformer 1012 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 10, a short sequence of tokens 1002 corresponding to the input text is illustrated as input to the transformer 1012. Tokenization of the text sequence into the tokens 1002 can be performed by some pre-processing tokenization module such as, for example, a byte-pair encoding tokenizer (the “pre” referring to the tokenization occurring prior to the processing of the tokenized input by the LLM), which is not shown in FIG. 10 for brevity. In general, the token sequence that is inputted to the transformer 1012 can be of any length up to a maximum length defined based on the dimensions of the transformer 1012. Each token 1002 in the token sequence is converted into an embedding vector 1006 (also referred to as “embedding 1006”).

An embedding 1006 is a learned numerical representation (such as, for example, a vector) of a token that captures some semantic meaning of the text segment represented by the token 1002. The embedding 1006 represents the text segment corresponding to the token 1002 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 1006 corresponding to the “write” token will be closer to another embedding corresponding to the “jot down” token in the vector space as compared to the distance between the embedding 1006 corresponding to the “write” token and another embedding corresponding to the “summary” token.

The vector space can be defined by the dimensions and values of the embedding vectors. Various techniques can be used to convert a token 1002 to an embedding 1006. For example, another trained ML model can be used to convert the token 1002 into an embedding 1006. In particular, another trained ML model can be used to convert the token 1002 into an embedding 1006 in a way that encodes additional information into the embedding 1006 (e.g., a trained ML model can encode positional information about the position of the token 1002 in the text sequence into the embedding 1006). In some implementations, the numerical value of the token 1002 can be used to look up the corresponding embedding in an embedding matrix 1004, which can be learned during training of the transformer 1012.

The generated embeddings 1006 are input into the encoder 1008. The encoder 1008 serves to encode the embeddings 1006 into feature vectors 1014 that represent the latent features of the embeddings 1006. The encoder 1008 can encode positional information (i.e., information about the sequence of the input) in the feature vectors 1014. The feature vectors 1014 can have very high dimensionality (e.g., on the order of thousands or tens of thousands), with each element in a feature vector 1014 corresponding to a respective feature. The numerical weight of each element in a feature vector 1014 represents the importance of the corresponding feature. The space of all possible feature vectors 1014 that can be generated by the encoder 1008 can be referred to as a latent space or feature space.

Conceptually, the decoder 1010 is designed to map the features represented by the feature vectors 1014 into meaningful output, which can depend on the task that was assigned to the transformer 1012. For example, if the transformer 1012 is used for a translation task, the decoder 1010 can map the feature vectors 1014 into text output in a target language different from the language of the original tokens 1002. Generally, in a generative language model, the decoder 1010 serves to decode the feature vectors 1014 into a sequence of tokens. The decoder 1010 can generate output tokens 1016 one by one. Each output token 1016 can be fed back as input to the decoder 1010 in order to generate the next output token 1016. By feeding back the generated output and applying self-attention, the decoder 1010 can generate a sequence of output tokens 1016 that has sequential meaning (e.g., the resulting output text sequence is understandable as a sentence and obeys grammatical rules). The decoder 1010 can generate output tokens 1016 until a special [EOT] token (indicating the end of the text) is generated. The resulting sequence of output tokens 1016 can then be converted to a text sequence in post-processing. For example, each output token 1016 can be an integer number that corresponds to a vocabulary index. By looking up the text segment using the vocabulary index, the text segment corresponding to each output token 1016 can be retrieved, the text segments can be concatenated together, and the final output text sequence can be obtained.

In some implementations, the input provided to the transformer 1012 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computing System

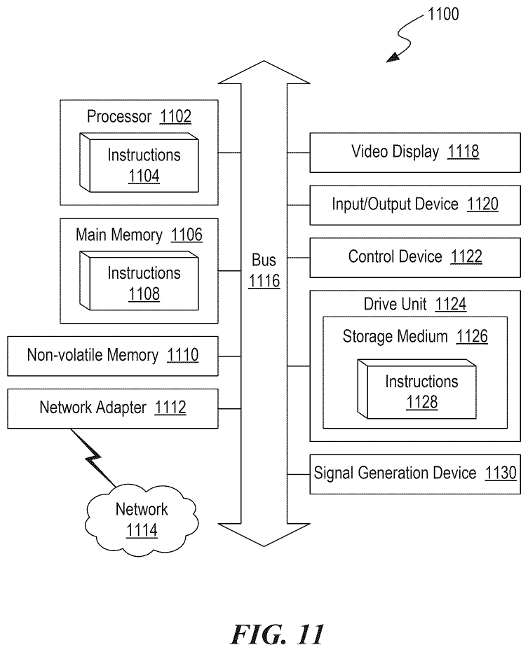

FIG. 11 is a block diagram illustrating an example computer system 1100, in accordance with one or more embodiments. At least some operations described herein are implemented on the computer system 1100. The computer system 1100 includes one or more central processing units (“processors”) 1102, main memory 1106, non-volatile memory 1110, network adapters 1112 (e.g., network interface), video displays 1118, input/output devices 1120, control devices 1122 (e.g., keyboard and pointing devices), drive units 1124 including a storage medium 1126, and a signal generation device 1130 that are communicatively connected to a bus 1116. The bus 1116 is illustrated as an abstraction that represents one or more physical buses and/or point-to-point connections that are connected by appropriate bridges, adapters, or controllers. In embodiments, the bus 1116 includes a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an IEEE standard 1394 bus (also referred to as “Firewire”).

In embodiments, the computer system 1100 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1100.

While the main memory 1106, non-volatile memory 1110, and storage medium 1126 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1128. The terms “machine-readable medium” and “storage medium” shall also be taken to include any medium that is capable of storing, encoding, or carrying a set of instructions for execution by the computer system 1100.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 1104, 1108, 1128) set at various times in various memory and storage devices in a computer device. When read and executed by the one or more processors 1102, the instruction(s) cause the computer system 1100 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1110, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1112 enables the computer system 1100 to mediate data in a network 1114 with an entity that is external to the computer system 1100 through any communication protocol supported by the computer system 1100 and the external entity. In embodiments, the network adapter 1112 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 1112 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application and the circumstances under which the permission rights stand.

### Examples

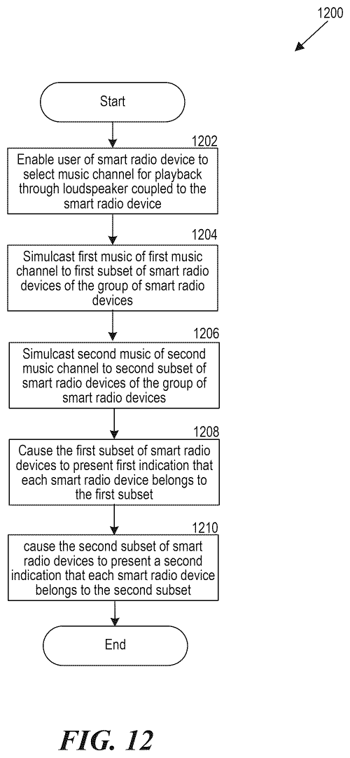

FIG. 12 is a flowchart that illustrates a method 1200 for orchestrating music on smart radio devices to improve engagement of frontline workers. The method 1200 can be performed by a system including a platform that hosts one or more smart radio devices at a facility. A smart radio device presents music to a user via a loudspeaker. In some aspects, the techniques described herein relate to a non-transitory, computer-readable storage medium including instructions recorded thereon, wherein the instructions, when executed by at least one data processor of a system that hosts the platform, cause the platform to perform the method 1200. The platform sets one or more parameters of playback of music at the smart radio device in accordance with one or more rules that are implemented for the facility.

At 1202, the system enables a user of the smart radio device to select a music channel for playback through a loudspeaker coupled to the smart radio device. The smart radio device is configured for two-way communication and belongs to a group of smart radio devices associated with a facility. Additionally, the system can cause the smart radio device to restore a value of the one or more parameters of playback of music in response to detecting that an event ended or after expiration of a period that began when the event was detected.

At 1204, the system can simulcast a first music of a first music channel to a first subset of smart radio devices of the group of smart radio devices. For example, the system can cause a first smart radio device of the first subset of smart radio devices to respond to an event detected at the facility by interrupting the first music on the first music channel with playback of an audio notification and cause a second smart radio device of the second subset of smart radio devices to respond to the event detected at the facility by attenuating volume of the second music on the second music channel to overlay the audio notification.

At 1206, the system can simulcast a second music of a second music channel to the second subset of smart radio devices of the group of smart radio devices. The second subset of smart radio devices is different from the first subset of smart radio devices. The difference between smart radio devices is based on the groupings that occur within the facility. In one example, the system can select an audio notification for playback on the group of smart radio devices and translate the audio notification into respective preferred languages of users for playback on the group of smart radio devices. In another example, the system can generate, based on a generative artificial intelligence system, an audio notification for playback during or instead of a first or second music rendered on the group of smart radio devices, where the audio notification is generated based on respective profiles of users of the group of smart radio devices and a profile of the facility.

At 1208, the system can cause the first subset of smart radio devices to present a first indication that each smart radio device belongs to the first subset of smart radio devices. For example, the system can set one or more parameters of playback at the group of smart radio devices in accordance with one or more rules that are implemented for the facility and dynamically control the one or more parameters responsive to one or more workflows including presence of the user in geofenced locations of the facility and presence of devices. The group of smart radio devices are each configured to host a mobile app that enables selection from among multiple music channels available for playback, where the one or more parameters are controlled by the platform hosted on the server system via instances of an operating system, mobile device management app, or mobile application management app that are hosted at the group of smart radio devices.

At 1210, the system can cause the second subset of smart radio devices to present a second indication that each smart radio device belongs to the second subset of smart radio devices. The first indication can be different from the second indication, and each is perceivable by people other than users of the group of smart radio devices. In one example, the first indication includes a first color or pattern of light emitted by each of the first subset of smart radio devices, and the second indication includes a second color or pattern of light emitted by each of the second subset of smart radio devices.

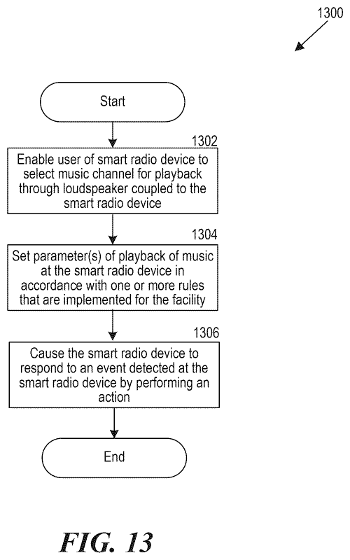

FIG. 13 is a flowchart that illustrates a method 1300 for enhancing worker management and safety using smart radio devices via an audio notification. The method 1300 can be performed by a system including a platform that hosts one or more smart radios at a facility. In some aspects, the techniques described herein relate to a non-transitory, computer-readable storage medium including instructions recorded thereon, wherein the instructions, when executed by at least one data processor of a server system that hosts a platform, cause the platform to perform the method 1300. For example, the system can cause the smart radio device to generate, based on a generative AI system, an audio notification for playback during or instead of the music being rendered on the smart radio device. In one example, the audio notification is generated based on a profile of the user and a profile of the facility, and an audio notification is played back to interrupt or overlay the music.

At 1302, the system enables a user of a smart radio device to select a music channel for playback through a loudspeaker coupled to the smart radio device, where the smart radio device is configured for two-way communications and belongs to a group of smart radio devices associated with a facility. In one example, the system broadcasts different music channels simultaneously to different subsets of the group of smart radio devices. In another example, the system configures the smart radio device to host a mobile app that enables selection of the music channel from among multiple available music channels for playback at the smart radio device.

At 1304, the system sets one or more parameters of playback of music at the smart radio device in accordance with one or more rules that are implemented for the facility, wherein one or more parameters are controlled by the platform hosted on the server system via an operating system, mobile device management app, or mobile application management app that is hosted on the smart radio device. For example, the system dynamically controls the one or more parameters responsive to a workflow including presence of the user in geofenced locations of the facility or presence of devices relative to the smart radio device.

At 1306, the system causes the smart radio device to respond to an event detected at the smart radio device by performing an action, where the event is based on a location of the smart radio device relative to a geofenced area of the facility or presence of a device, equipment, or machine in a threshold vicinity of the smart radio device and wherein performing the action includes modifying a value of the one or more parameters of playback of music. In one example, the platform causes the smart radio device to restore the value of the one or more parameters of playback of music in response to detecting that the event ended or after expiration of a time period that began when the event was detected.

In one example, the system performs the action to interrupt playback of the music on the music channel with an audio notification. For example, performing the action can include causing the smart radio device to attenuate volume of the music on the music channel for a time period. Playback can be overlying an audio notification during the time period. In another example, the system causes the smart radio device to select an audio notification to play during or in place of the music on the smart radio device, convert the audio notification into a preferred language of the user as indicated in a profile of the user, and play the audio notification to interrupt or overlay the music.

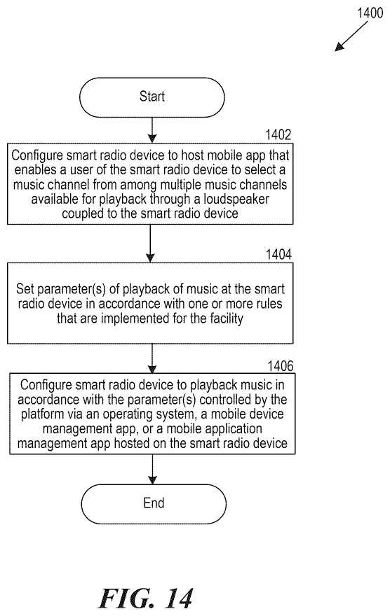

FIG. 14 is a flowchart that illustrates a method 1400 to control playback parameters via an operating system, mobile device management app, or mobile application management app hosted on the smart radio device to enhance worker management and safety through dynamic control and event-triggered actions. The method 1400 can be performed by a system including a platform that hosts one or more smart radios at a facility. In some aspects, the techniques described herein relate to a non-transitory, computer-readable storage medium including instructions recorded thereon, wherein the instructions, when executed by at least one data processor of a server system that hosts a platform, cause the platform to perform the method 1400.

At 1402, the system configures a smart radio device to host a mobile app that enables a user of the smart radio device to select a music channel from among multiple music channels available for playback through a loudspeaker coupled to the smart radio device, where the smart radio device is configured for two-way communications and belongs to a group of smart radio devices hosted by the platform and is associated with a facility. For example, the system streams a first music channel to a first subset of smart radio devices, streams a second music channel to a second subset of smart radio devices different from the first subset of smart radio devices, causes the first subset of smart radio devices to present a first human perceptible output indicating that each device belongs to the first subset of smart radio devices, and causes the second subset of smart radio devices to present a second human perceptible output indicating that each device belongs to the second subset of smart radio devices. In one example, the first human perceptible output and the second human perceptible output are different and perceivable to non-users of the smart radio device.

At 1404, the system sets one or more parameters of playback of music at the smart radio device in accordance with one or more rules that are implemented for the facility. For example, the system can dynamically control via an operating system, a mobile device management app, or a mobile application management app one or more parameters. For example, the system causes the smart radio device to respond to an event detected at the facility by changing a volume of the music on the music channel and causing playback of an audio notification while the volume is changed.

At 1406, the system configures the smart radio device to play back music in accordance with the one or more parameters controlled by the platform via an operating system, a mobile device management app, or a mobile application management app hosted on the smart radio device. In one example, the system responds to an event detected at the facility by performing an action. The event can be based on a location of the smart radio device relative to a geofenced area of the facility or presence of a device, equipment, or machine in a threshold vicinity of the smart radio device and wherein to perform the action includes modifying a value of the one or more parameters of playback of music. In another example, the system causes the smart radio device to respond to an event detected at the facility by performing playback of an audio notification to accompany the music.

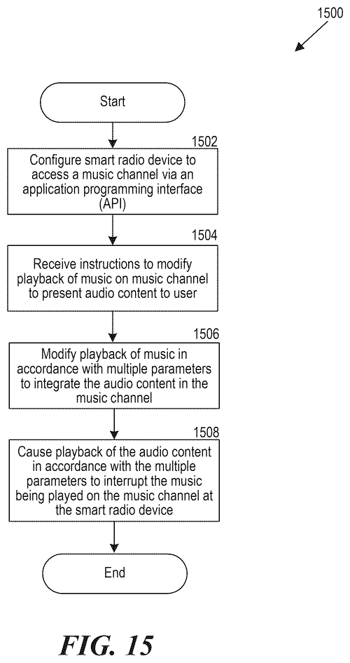

FIG. 15 is a flowchart that illustrates a method 1500 for modifying music playback via one or more application programming interfaces (APIs). The method 1500 can be performed by a system including a platform that hosts one or more smart radio devices at a facility. In some aspects, the techniques described herein relate to a non-transitory, computer-readable storage medium including instructions recorded thereon, wherein the instructions, when executed by at least one data processor of a system that hosts a platform, cause the platform to perform the method 1500. In one example, the system controls, by the platform executing commands received via the API, the smart radio device to play back the music on the music channel, modify audio data for the audio content, and modify the playback of the audio content in accordance with the multiple parameters. For example, the system generates, based on a generative artificial intelligence system, the audio content for playback during or instead of the music being rendered on the smart radio device. In one example, the audio content is generated based on a profile of the user and a profile of the facility, and an audio content is played back to interrupt the music.

At 1502, the system configures a smart radio device to access a music channel, wherein the smart radio device is configured to access the music channel via an application programming interface (API). In one example, the system enables a user of a smart radio device to select a music channel for playback through a loudspeaker coupled to the smart radio device. The API is configured to select one or more rules in a ruleset from among multiple rulesets for a type of loudspeaker of the smart radio device corresponding to over-ear headphones, on-ear headphones, earbuds, noise-canceling headphones, bone conduction headphones, boom mics, standalone speakers, or speakers integrated into smart radio devices.

In another example, the system enables simulcast of a first music of a first music channel across a first subset of smart radio devices of a group of smart radio devices and enables simulcast of a second music of a second music channel across a second subset of smart radio devices of the group of smart radio devices. The second subset of smart radio devices can be different from the first subset of smart radio devices. The system causes the first subset of smart radio devices to present a first indication that each smart radio belongs to the first subset of smart radio devices and causes the second subset of smart radio devices to present a second indication that each smart radio belongs to the second subset of smart radio devices. In one example, the first indication is different from the second indication, which are each perceivable to people who are not users of any of the group of smart radio devices.

At 1504, the system receives instructions to modify a playback of music on the music channel to present an audio content to a user. The instructions can indicate multiple parameters associated with the smart radio device to modify the playback of the music on the music channel, modify audio data for the audio content, and modify the playback of the audio content. The playback of the music from the music channel can be modified in accordance with a predetermined threshold for volume, timing, priority, and audio data depending on one or more rules set by the facility to integrate the audio content. In one example, the system selects the audio content for playback during or instead of the music being rendered on the smart radio device, translates the audio content into a preferred language of the user as indicated in a profile of the user, and plays back the audio content to interrupt the music.

At 1506, the system modifies playback of the music in accordance with the multiple parameters to integrate the audio content in the music channel. The audio content includes a notification associated with the facility, where the audio content is configured to interrupt the music by modulating a volume of the music and playing the notification. The system can dynamically control the multiple parameters of playback of the music responsive to a workflow including presence of the user in geofenced locations of the facility and presence of devices in a threshold proximity to the smart radio device. For example, the system modulates volume of the music on the music channel for a time period and plays back an audio notification during the time period to interrupt modulated volume of the music being played on the music channel.

At 1508, the system causes playback of the audio content in accordance with the multiple parameters to interrupt the music being played on the music channel at the smart radio device. In one example, the system enables the user of the smart radio device to select the music channel from among multiple available music channels for playback through a loudspeaker coupled to the smart radio device. The system can cause interruption of playback of the music on the music channel for a time period and play back an audio notification during the time period. In another example, the system sets the multiple parameters of playback of music at the smart radio device in accordance with one or more rules that are implemented for the facility. The system can cause the smart radio device to respond to an event detected at the smart radio device by performing an action. The event can be based on a location of the smart radio device relative to a geofenced area of the facility or presence of a device, equipment, or machine in a threshold vicinity of the smart radio device. In one example, performing the action includes modifying a value of the multiple parameters of playback of music and causing the smart radio device to restore the value of the multiple parameters of playback of music in response to detecting that the event ended or after expiration of a time period that began when the event was detected.

### Remarks

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. One will recognize that “memory” is one form of a “storage” and that the terms are on occasion used interchangeably.

Consequently, alternative language and synonyms are used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

1. A non-transitory, computer-readable storage medium comprising instructions recorded thereon, wherein the instructions, when executed by at least one data processor of a server system that hosts a platform, cause the platform to:
enable a user of a smart radio device to select a music channel for playback through a loudspeaker coupled to the smart radio device,
wherein the smart radio device is configured for two-way communication and belongs to a group of smart radio devices associated with a facility;
simulcast a first music of a first music channel to a first subset of smart radio devices of the group of smart radio devices;
simulcast a second music of a second music channel to a second subset of smart radio devices of the group of smart radio devices,
wherein the second subset of smart radio devices is different from the first subset of smart radio devices;
cause the first subset of smart radio devices to present a first indication that each smart radio device belongs to the first subset of smart radio devices; and
cause the second subset of smart radio devices to present a second indication that each smart radio device belongs to the second subset of smart radio devices,
wherein the first indication is different from the second indication and each is perceivable by other than users of the group of smart radio devices.

2. The non-transitory, computer-readable storage medium of claim 1:
wherein the first indication includes a first color or pattern of light emitted by each of the first subset of smart radio devices, and
wherein the second indication includes a second color or pattern of light emitted by each of the second subset of smart radio devices.

3. The non-transitory, computer-readable storage medium of claim 1, wherein the platform is further caused to:
set one or more parameters of playback of music at the smart radio device in accordance with one or more rules that are implemented for the facility.

4. The non-transitory, computer-readable storage medium of claim 3, wherein the platform is further caused to:
cause the smart radio device to restore a value of the one or more parameters of playback of music in response to detecting that an event ended or after expiration of a time period that began when the event was detected.

5. The non-transitory, computer-readable storage medium of claim 1, wherein the platform is further caused to:
cause a first smart radio device of the first subset of smart radio devices to respond to an event detected at the facility by interrupting the first music on the first music channel with playback of an audio notification; and
cause a second smart radio device of the second subset of smart radio devices to respond to the event detected at the facility by attenuating volume of the second music on the second music channel to overlay the audio notification.

6. The non-transitory, computer-readable storage medium of claim 1, wherein the platform is further caused to:
select an audio notification for playback on the group of smart radio devices; and
translate the audio notification into respective preferred languages of users for playback on the group of smart radio devices.

7. The non-transitory, computer-readable storage medium of claim 1, wherein the platform is further caused to:
generate, based on a generative artificial intelligence system, an audio notification for playback during or instead of a first or second music rendered on the group of smart radio devices,
wherein the audio notification is generated based on respective profiles of users of the group of smart radio devices and a profile of the facility.

8. The non-transitory, computer-readable storage medium of claim 1, wherein the platform is further caused to:
set one or more parameters of playback at the group of smart radio devices in accordance with one or more rules that are implemented for the facility; and
dynamically control the one or more parameters responsive to one or more workflows including presence of the user in geofenced locations of the facility and presence of devices.

9. The non-transitory, computer-readable storage medium of claim 1, wherein the platform is further caused to:
set one or more parameters of playback at the group of smart radio devices in accordance with one or more rules that are implemented for the facility,
wherein the group of smart radio devices are each configured to host a mobile app that enables selection from among multiple music channels available for playback; and
wherein the one or more parameters are controlled by the platform hosted on the server system via instances of an operating system, mobile device management app, or mobile application management app that are hosted at the group of smart radio devices.

10. The non-transitory, computer-readable storage medium of claim 1, wherein the platform is further caused to:
set one or more parameters of playback at the group of smart radio devices in accordance with a ruleset that is implemented for the facility,
wherein a rule from the ruleset is selected for a type of loudspeaker of a respective smart radio device, the type of loudspeaker corresponding to:
over-ear headphones,
on-ear headphones,
earbuds,
noise-canceling headphones,
bone conduction headphones,
boom mics,
standalone speakers, or
speakers integrated in smart radio devices.

11. A non-transitory, computer-readable storage medium comprising instructions recorded thereon, wherein the instructions, when executed by at least one data processor of a server system that hosts a platform, cause the platform to:
enable a user of a smart radio device to select a music channel for playback through a loudspeaker coupled to the smart radio device,
wherein the smart radio device is configured for two-way communications and belongs to a group of smart radio devices associated with a facility;
set one or more parameters of playback of music at the smart radio device in accordance with one or more rules that are implemented for the facility;
cause the smart radio device to respond to an event detected at the smart radio device by performing an action,
wherein the event is based on a location of the smart radio device relative to a geofenced area of the facility or presence of a device, equipment, or machine in a threshold vicinity of the smart radio device, and
wherein performing the action includes modifying a value of the one or more parameters of playback of music.

12. The non-transitory, computer-readable storage medium of claim 11, wherein the platform is further caused to:
cause the smart radio device to restore the value of the one or more parameters of playback of music in response to detecting that the event ended or after expiration of a time period that began when the event was detected.

13. The non-transitory, computer-readable storage medium of claim 11, wherein the platform is further caused to:
broadcast different music channels simultaneously to different subsets of the group of smart radio devices.

14. The non-transitory, computer-readable storage medium of claim 11, wherein to perform the action comprises causing the smart radio device to:
interrupt playback of the music on the music channel with an audio notification.

15. The non-transitory, computer-readable storage medium of claim 11, wherein to perform the action comprises causing the smart radio device to:
attenuate volume of the music on the music channel for a time period; and
overlay playback of an audio notification during the time period.

16. The non-transitory, computer-readable storage medium of claim 11, wherein to perform the action comprises causing the smart radio device to:
select an audio notification to play during or in place of the music on the smart radio device;
convert the audio notification into a preferred language of the user as indicated in a profile of the user; and
play the audio notification to interrupt or overlay the music.

17. The non-transitory, computer-readable storage medium of claim 11, wherein to perform the action comprises causing the smart radio device to:
generate, based on a generative artificial intelligence system, an audio notification for playback during or instead of the music being rendered on the smart radio device,
wherein the audio notification is generated based on a profile of the user and a profile of the facility; and
play back an audio notification to interrupt or overlay the music.

18. The non-transitory, computer-readable storage medium of claim 11, wherein the platform is further caused to:
dynamically control the one or more parameters responsive to a workflow including presence of the user in geofenced locations of the facility or presence of devices relative to the smart radio device.

19. The non-transitory, computer-readable storage medium of claim 1, wherein the smart radio device is configured to host a mobile app that enables selection of the music channel from among multiple available music channels for playback at the smart radio device.

20. The non-transitory, computer-readable storage medium of claim 1, wherein one or more parameters are controlled by the platform hosted on the server system via an operating system, mobile device management app, or mobile application management app that is hosted on the smart radio device.
